(19) United States
(12) Patent Application Publication
(10) Pub. No.: US 2016/0357903 A1
(43) Pub. Date: Dec. 8, 2016

(54) A FRAMEWORK FOR DETERMINING THE RELATIVE EFFECT OF GENETIC VARIANTS

(71) Applicants: UNIVERSITY OF WASHINGTON THROUGH ITS CENTER FOR COMMERCIALIZATION, Seattle, WA (US); HUDSONSALPHA INSTITUTE FOR BIOTECHNOLOGY, Huntsville, AL (US)

(72) Inventors: Jay Shendure, Seattle, WA (US); Gregory M Cooper, Huntsville, AL (US); Martin Kircher, Seattle, WA (US); Daniela Witten, Seattle, WA (US)

(73) Assignees: University of Washington through its Center for Commercialization, Seattle, WA (US); Hudsonsalpha Institute for Biotechnology, Huntsville, AL (US)

(21) Appl. No.: 15/023,355

(22) PCT Filed: Sep. 20, 2014
(86) PCT No.: PCT/US2014/056701

§ 371 Date: Mar. 18, 2016

Related U.S. Application Data
(60) Provisional application No. 61/880,286, filed on Sep. 20, 2013.

(51) Int. Cl. G06F 19/22; G06F 19/24

(52) U.S. Cl. CPC G06F 19/22; G06F 19/24

(57) ABSTRACT

Current methods for annotating and interpreting human genetic variation typically exploit only a single information type (e.g., conservation) and/or are restricted in scope (e.g., to missense changes). Here, a method for objectively integrating many diverse annotations into a single measure (integrated deleteriousness score, or C-score) for each variant is described. The method may be implemented as a support vector machine (SVM) trained to differentiate high-frequency human-derived alleles from simulated variants. C-scores were precomputed for all 8.6 billion possible human single-nucleotide variants and allow scoring of short insertions-deletions. C-scores correlate with allelic diversity, annotations of functionality, pathogenicity, disease severity, experimentally measured regulatory effects and complex trait associations, and they highly rank known pathogenic variants within individual genomes. The ability of CADD to prioritize functional, deleterious and pathogenic variants across many functional categories, effect sizes and genetic architectures is unmatched by any current single-annotation method.

### CROSS-REFERENCE TO RELATED APPLICATION(S)

This application claims priority to U.S. Provisional Application No. 61/880,286, filed Sep. 20, 2013, the subject matter of which is hereby incorporated by reference as if fully set forth herein.

### STATEMENT REGARDING FEDERALLY SPONSORED RESEARCH

This invention was made with government support under Grant No. U54HG006493, awarded by the National Human Genome Research Institute and Grant Nos. DP1HG007811 and DP50D009145, awarded by the National Institutes of Health. The government has certain rights in the invention

### BACKGROUND

Genomic approaches in studying disease provide useful tools in the field, such as the ability to replace informed but biased hypotheses with unbiased but generic ones, such as the equal treatment of all genetic variants in genome-wide association studies (GWAS). However, for both rare variants of large effect and common variants of weak effect, the use of prior knowledge can be critical for disease gene discovery (Cooper et al. 2010; Cooper et al. 2011(a); Musunuru et al. 2010; Ward & Kellis 2012). For example, exome sequencing is an effective discovery strategy because it focuses on protein-altering variation, which is enriched for causal effects (Ng et al. 2009).

Although many existing annotation methods are useful for prioritizing causal variants to boost discovery power (for example, PolyPhen (Adzhubei et al. 2010), SIFT (Ng & Henikoff 2003) and GERP (Cooper et al. 2005)), current approaches tend to suffer from one or more major limitations. First, annotation methods vary widely with respect to both inputs and outputs. For example, conservation metrics (Cooper et al. 2005; Siepel et al. 2005; Pollard et al. 2010) are defined across the genome but do not use functional information and are not allele specific, whereas protein-based metrics (Adzhubei et al. 2010; Ng. & Henikoff 2003) apply only to coding and often only to missense variants, thereby excluding >99% of human genetic variation. Further, each annotation method has its own metric, and these metrics are rarely comparable, making it difficult to evaluate the relative importance of distinct variant categories or annotations. Additionally, annotation methods trained on known pathogenic mutations are subject to major ascertainment biases and may not be generalizable. Moreover, it is a major practical challenge to obtain, let alone to objectively evaluate or combine, the existing panoply of partially correlated and partially overlapping annotations; this challenge will only increase in size as large-scale projects such as the Encyclopedia of DNA Elements (ENCODE) (ENCODE Project Consortium et al. 2012) continually increase the amount of relevant data available. The net result of these limitations is that many potentially relevant annotations are ignored, while the annotations that are used are applied and combined in ad hoc and subjective ways that undermine their usefulness. Therefore, it would be useful to develop a framework which would provide a single metric to prioritize variants across annotation methods.

### SUMMARY

According to the embodiments described herein a method performed by a computing system for determining the relative effect of a genetic variant is provided. The method may include a set of applying a machine learning model to a dataset, wherein the dataset comprises one or more genetic variants, each of which is associated with values or states of each of a set of annotations. In some aspects, the machine learning model is a support vector machine (SVM) model. The method may also include a step of calculating and/or assigning (e.g., a raw integrated deleteriousness score or a scaled integrated deleteriousness score) for each of the one or more genetic variants. The integrated deleteriousness score of each genetic variant may be used to determine the relative effect of said genetic variant when compared to other integrated deleteriousness scores.

In certain embodiments, a system for generating an integrated deleteriousness score is provided. The system may include a computer-readable storage medium which stores computer-executable instructions. In some aspects, the computer-executable instructions include, but are not limited to (i) instructions for applying a machine learning model to a dataset, wherein the dataset comprises one or more genetic variants, each of which is associated with values or states of each of a set of annotations; and/or (ii) instructions for calculating an integrated deleteriousness score to each of the one or more genetic variants. They system may also include a processor. In some aspects, the processor may be configured to perform steps including, but not limited to, receiving the dataset by a user and/or executing the computer-executable instructions stored in the computer-readable storage medium.

In certain embodiments, a computer-readable storage medium is provided. Such a computer-readable storage medium may store computer-executable instructions including, but not limited to (i) instructions for applying a machine learning model to a dataset, wherein the dataset comprises one or more genetic variants, each of which is associated with values or states of each of a set of annotations, and/or (ii) instructions for calculating an integrated deleteriousness score to each of the one or more genetic variants.

### BRIEF DESCRIPTION OF THE DRAWINGS

FIG. 1 is a table which includes columns of the extended annotation Tables according to one embodiment. Parentheses around the column name indicate that the column is not used for model training or prediction of pathogenicity.

FIG. 2 is a table showing the imputation of missing values for model training and prediction according to one embodiment. An asterisk (*) indicates that a Boolean indicator variable was created in order to handle undefined values for that feature. “Dropped” indicates that a variant missing a value for this specific feature was not used for training. A double plus sign (++) indicates default imputation values in the case where missing values could not be inferred.

FIG. 3 is a table showing univariate analyses for SNVs according to one embodiment. The “Relevance” column reports the fraction of SNVs for which a particular feature is defined; each logistic regression model was only fit on the SNVs for which the corresponding feature is relevant. Depletion is defined as (fraction of observed sites among the x % predicted to be most deleterious)/(fraction of observed sites in the full data set); a value of 1 is expected by chance, and a small value indicates that the sites predicted to be most deleterious are predominantly simulated.

FIG. 4 is a table showing univariate analyses for deletions according to one embodiment. Details are as in FIG. 3.

FIG. 5 is a table showing univariate analyses for insertions according to one embodiment. Details are as in FIG. 3.

FIG. 6A shows a heatmap of feature correlations among observed single nucleotide variants (SNVs) according to one embodiment.

FIG. 6B shows a heatmap of feature correlations among simulated SNVs according to one embodiment.

FIG. 7 shows that interaction terms only improve a small subset of two-feature linear regression models for predicting whether a variant is observed or simulated according to one embodiment. For each pair of features, the ratio (AUC for a linear regression model with interaction)/(AUC for a linear regression model with only main effects) is shown. A large ratio indicates a pair of features for which including an interaction term leads to improvement in the model. For nearly all pairs of features, the inclusion of an interaction in the model leads to little improvement in AUC. Models were fit to SNVs only. White squares indicate pairs of features for which the ratio was not computed.

FIG. 8 shows univariate models of distance to splice junction according to one embodiment. Logistic regression models were fit to the SNVs in order to predict whether a variant is observed or simulated, using the variant's distance from splice site (treated as a categorical variable) for sites in the exon donor, intron donor, intron acceptor, and exon acceptor regions. The red dots indicate the probability that a variant is observed (as opposed to simulated) given its splice position. The gray line indicates the overall fraction of variants in the exon donor, intron donor, intron acceptor, and exon acceptor region that are observed (as opposed to simulated). 95% confidence intervals are shown.

FIG. 9 is a table that illustrates the depletion of observed SNVs in each consequence bin according to one embodiment, computed as (fraction of observed sites in a given consequence bin)/(fraction of observed sites in the full data set); the denominator is ½. Values presented are averages across ten different training data samples, followed by the range. A small value indicates a consequence bin containing fewer observed SNVs than expected by chance. The numbers of observed and simulated SNVs within each consequence bin are also reported. Here, “canonical splice site” is defined as a site in the two-base region at the 5′ end of an intron or in the two-base region at the 3′ end of an intron. Sites that are within 1-3 bases of the exon or 3-8 bases of the intron are defined as “non-canonical splice sites”.

FIG. 10 is a table showing the interaction of SNV consequence and cDNA position according to one embodiment. A logistic regression model was fit in order to predict whether a SNV within a cDNA is observed or simulated, based on the Consequence label, the relative position of the variant along the cDNA (from 0 to 1), and an interaction between those two terms. Coefficients, standard errors, and p-values for the interactions are shown. A smaller coefficient value indicates a Consequence bin that tends to be less associated with deleteriousness when it occurs later in the cDNA. A larger coefficient value indicates the opposite.

FIG. 11 is a graph representing an exemplar hyperplane and margins for a support vector machine (SVM) trained with samples from two classes according to one embodiment. The training matrix rows correspond to the variants of the training set or dataset (29.4M variants; y=0 for proxy benign, y=1 for proxy deleterious); and the columns correspond to annotations (947), wherein X1, . . . , Xn→63 annotations.

FIG. 12 shows SVM model training convergence in 2000 iterations (˜70 h) for different settings of the generalization parameter C according to one embodiment. Training with C=0.0025 or C=0.001 successfully converged in this timeframe. On the y-axis, 1-QD/DP indicates the relative reduction in the objective value over subsequent iterations; a small value indicates convergence.

FIG. 13 shows Pearson and Spearman correlation between ten models (1-10) and the average of the ten models (Ave) according to some embodiments. The models were obtained from different training data samples for predicted values of 100,000 random single nucleotide variants from the 1000 Genomes project (FIG. 13A (Pearson); FIG. 13B (Spearman)) as well as 100,000 random substitutions from GRCh37/hg19 chromosome 21 (FIG. 13C (Pearson); FIG. 13D (Spearman)).

FIG. 14 shows the relationship of scaled C-scores and categorical variant consequences according to one embodiment. (a) Proportion of substitutions with a specific consequence for each scaled C-score bin. (b) Proportion of substitutions with a specific consequence after first normalizing by the total number of variants observed in that category. The legend includes in parentheses the median and range of scaled C-score values for each category. Consequences were obtained from Ensembl VEP (McClaren et al. 2010); for example, noncoding refers to changes in annotated noncoding transcripts. Detailed counts of functional assignments in each C-score bin are provided in Supplementary Table 8. (c) Violin plots of the median C-scores of potential nonsense (stop-gain) variants for genes that harbor at least 5 known pathogenic mutations (Stenson et al. 2009) (disease); are predicted to be essential (Liao & Zhang 2008); harbor variants associated with complex traits (Hindorff et al. 2009) (GWAS); harbor at least 2 loss-of-function (LoF) mutations in 1000 Genomes Project data (MacArthur et al. 2012); encode olfactory receptor proteins; or are in a random selection of 500 genes.

FIG. 15 is a table showing the distribution of 8,594,355,672 scaled C-scores according to one embodiment for all possible GRCh37/hg19 single nucleotide substitutions across categorical variant consequence bins. Consequences are obtained from Ensembl Variant Effect Predictor (McLaren et al. 2010) output (see Supplemental Methods), e.g. “noncoding” refers to changes in annotated non-coding transcripts.

FIG. 16 shows violin plots of the median SNV C-score across the genes coding sequence (padded by 10 bp non-coding sequence around each exon), putative missense (non-synonymous) variants and putative non-sense (stop-gained) variants for different functional gene categories, according to one embodiment. The sources for genes comprising each category are described in the Examples below.

FIG. 17 shows the relationship between scaled C-scores and genetic variation according to one embodiment. (a) Mean DAF by scaled C-score for variants listed by the 1000 Genomes Project (1000 Genomes Project Consortium et al. 2012) or ESP (Fu et al. 2013). Dashed lines indicate mean DAF values, and confidence intervals indicate 1.96× s.e.m. for DAFs in each bin. (b) Under-representation of polymorphic sites in 1000 Genomes Project data. (c) Under-representation of chimpanzee lineage—derived variants. Under-representation is defined as the proportion of 1000 Genomes Project (b) or chimpanzee-derived (c) variants in a specific scaled C-score bin divided by the frequency with which that scaled C-score is observed for all possible mutations of the human reference assembly (10^{C-score/-10}). The stronger under-representation of chimpanzee-derived variants relative to 1000 Genomes Project variants is expected given that the former are mostly fixed or high-frequency variants (and have survived many generations of purifying selection), whereas the latter are mostly low-frequency variants. Depletion values in b,c for C-score bins other than 0 are significantly different from expectation (binomial proportion test, all P<1×10⁻¹¹).

FIG. 18 shows the relationship of derived allele frequency of 1000 Genome SNVs with C-scores according to one embodiment. Although no information pertaining to DAF was used to calculate C-scores, a significant negative correlation is observed (Spearman rank correlation −0.0825, n=36,853,235, p-value <10⁻³⁰⁰). The over-representation of low C-scores (green to yellow colors) for high frequency derived alleles as well as the over-representation of high C-scores (red to white color range) for low frequency derived alleles is driving this correlation.

FIG. 19 shows a smoothed scatterplot representation of derived allele frequency and unscaled C-scores according to one embodiment. A significant negative correlation is observed for SNVs (FIG. 19A; Spearman rank correlation −0.0825, n=36,853,235, p-value <10⁻³⁰⁰) and InDels (FIG. 19B; Spearman rank correlation −0.0688, n=1,388,296, p-value <10⁻³⁰⁰).

FIG. 20 shows the relationship between scaled C-scores and standing variation in the human population based on the average derived allele frequency (DAF) per C-score bin for variants identified in the 1000 Genomes Project (1000 Genomes Project Consortium et al. 2012), according to one embodiment. The black line in this FIG. is identical to the black line in the upper panel of FIG. 17, while colored lines show the stratification for different values of the model's input features GC content, CpG content, B-score (bStatistic) and GerpS. The % of total sites associated with each stratification bin is provided in parentheses in the legend.

FIG. 21 is a table showing a comparison of metrics for scoring de novo variants in autism spectrum disorder probands (ASD) and intellectual disability probands (ID) according to one embodiment. P-values of a Wilcoxon rank sum test (with continuity correction) are provided for testing different groups of ASD and unaffected siblings (sib) and/or ID probands (pb) and unrelated control children (ct). “Shift” is “+” if values in the first group tested are larger and “−” if values in the second group tested are higher. “Counts” specifies the number of sites considered in both categories tested and “% used” provides the total fraction of sites being used for the test. “Fully def.” are the subset of sites for which a score is available for all metrics evaluated. Note that SIFT scores have a negative score orientation (i.e. more deleterious variants are assigned lower scores), while all other scores reported use a positive score orientation.

FIG. 22 shows discrimination of disease-associated MLL2 alleles versus rare, apparently benign alleles in MLL2 obtained from ESP, according to one embodiment. Shown are boxplots for all observed variants (upper panel) as well as restricted to non-synonymous variants (lower panel). P-values for the Wilcoxon rank sum test with continuity correction testing a difference between the sets of pathogenic (n=210) and benign (n=679) variants (upper panel) are C-scores: 9.87×10⁻⁹⁴, GerpS: 1.94×10⁻⁴¹, mammalian PhastCons: 1.78×10⁻²⁶, and mammalian PhyloP: 1.28×10⁻⁴¹. The respective p-values of the lower panel are C-score: 1.09×10⁻⁷ (n=33/273), PolyPhen 5.39×10⁻² (n=2/12), SIFT 1.38×10⁻¹ (n=2/8), Grantham 4.20×10⁻² (n=33/273). Note that PolyPhen and SIFT scores are not available from VEP for the overwhelming majority of missense variants in MLL2, limiting those comparisons.

FIG. 23 shows a boxplot with notches (Chambers et al. 1983) and without outliers for C-scores, GerpS, mammalian PhastCons (mamPhCons) and mammalian PhyloP (mamPhyloP) scores for HBB disease variants grouped by severity [mild: beta+(n=48), intermediate: other (n=65), and severe: beta0 (n=99)], according to one embodiment. Only 22 out of 212 reported variants result in a missense event; therefore scoring of these variants is largely limited to conservation-based measures. A Kruskal-Wallis rank sum test for the separation of the three disease types using C-scores yields a chi-squared of 30.4665 (df=2, p-value=2.42×10⁻⁷). It clearly outperforms the three conservation-based measures: GerpS chi-squared=17.2366 (p-value=1.81×10⁻⁴), mamPhCons chi-squared=19.917 (p-value=4.73×10⁻⁵), and mamPhyloP chi-squared=21.3717 (p-value=2.29×10⁻⁵).

FIG. 24 shows the sensitivity of methods in distinguishing pathogenic and benign variants according to one embodiment. Receiver operating characteristics (ROCs) are shown discriminating curated, pathogenic mutations defined by the ClinVar database (Baker 2012) from matched, likely benign ESP alleles (DAF≧5%) (Fu et al. 2013) with the same categorical consequence. (a) Genome-wide variants for which GerpS, PhCons and phyloP scores are defined (n=16,334). (b) Analysis limited to missense changes (n=15,154), with missing values imputed to an upper limit of each score. (c) Analysis limited to missense changes for which PolyPhen, SIFT and Grantham scores are all defined (n=13,358). Versions of the plot in c that exclude overlap between PolyPhen training data and the ClinVar database or use a CADD model trained without PolyPhen as a feature are shown in FIG. 25. Area under the curve (AUC) values are provided for each of the scores used.

FIG. 25 shows receiver operating characteristics (ROC) for discriminating pathogenic variants curated by the NIH ClinVar database (Baker 2012) from apparently benign variants (AF≧5%) selected from the Exome Sequencing Project (Tennessen et al. 2012) (ESP) to match the categorical consequences observed in the ClinVar pathogenic data set according to one embodiment. The left panel shows results for a model which has been trained without PolyPhen as input features. Shown is a ROC plot equivalent to FIG. 24(c), i.e. only variants for which all annotation scores are available are used. The right panel uses the same model/data presented in FIG. 24(c), but excludes variants identified to overlap the PolyPhen-2 training data set (HumVar: ftp://genetics.bwh.harvard.edu/pph2/training/training-2.2.2.tar.gz; ClinVar pathogenic: 4157/8174, ESP: 3706/8174). In both panels, a matching number of variants for ESP and ClinVar pathogenic were used.

FIG. 26 is a visual representation of the separation of the curated pathogenic mutations in the NIH ClinVar database (red, n=8174) and matched apparently benign (derived allele frequency of at least 5%) mutations in ESP with the same consequence values (blue, n=8174) for different scores according to one embodiment. Gray blocks indicate missing values for the score under consideration. P-values are given for a Wilcoxon rank sum test with continuity correction.

FIG. 27 shows receiver operating characteristics (ROC) for discriminating pathogenic variants curated by the NIH ClinVar database (Baker 2012) from variants selected from the Exome Sequencing Project (Tennessen et al. 2012) (ESP) to match the categorical consequences as well as the frequency observed in the ClinVar pathogenic data set to a 10⁻³ precision, according to some embodiments. Using this precision level, ClinVar pathogenic variants without ESP frequency were matched to ESP variants of a frequency below <0.0005. A total of 9,965 ClinVar pathogenic variants were matched to the same number of ESP variants. In both panels, a matching number of variants for ESP and ClinVar pathogenic were used.

FIG. 28 shows discriminating pathogenic variants curated by the NIH ClinVar database from ESP variants using alternative variant scores according to one embodiment. Here, variant scores available from dbNSFP 2.0 (Liu et al. 2011) were retrieved and compared to CADD. 7,864 out of 8,174 ESP and 8,171 out of 8,174 ClinVar pathogenic variants used in FIGS. 22-25 were retrieved from dbNSFP. The Table on the left shows the difference in area under the curve (AUC) between CADD and each of the retrieved scores as well as the proportion of sites for which each of the scores is available. In all pairwise comparisons, the AUC of CADD is higher than for the alternative method; moreover most alternative methods are defined for only a subset of sites. The right FIG. displays the ROC curve for the subset of sites where all scores are available.

FIG. 29 shows the ranking of pathogenic ClinVar missense variants among all the missense variants identified by whole genome sequencing of eleven human individuals from diverse populations, similar to the left panel of FIG. 31 in the main text according to one embodiment. Note that ranks are defined based on the number of variants in the genome that score strictly below the variant of interest, with tied variants all assigned the same value (e.g., if there are 100 variants total and the highest scoring 5 variants are tied, then they would each be ranked at the 5th-percentile).

FIG. 30 shows a Spearman (rank) and Pearson (linear) correlation between absolute expression fold change and the C-score for the respective substitution (FIG. 30A) according to one embodiment. Shown are two enhancers, ALDOB (777 variants) and ECR11 (1860 variants), and 210 promoter variants of the gene HBB. Combining all three data sets yields a Spearman rank correlation of 0.312 and p-value of 1.91×10⁻⁶⁵. Three conservation based methods (GerpS, mamPhCons, and mamPhyloP) yield lower Spearman rank correlations of 0.236 (1.85×10⁻³⁷), 0.240 (1.40×10⁻³⁸), and 0.193 (3.26×10⁻²⁵) for the combined data set (FIG. 30B).

FIG. 31 shows the ranking of pathogenic ClinVar variants among the variants identified by whole-genome sequencing in 11 human individuals from diverse populations according to one embodiment. (a) Cumulative distribution of the rankings of 9,831 pathogenic ClinVar variants when ‘spiked’ into each of 11 personal genomes. For example, C-scores of ˜30% for ClinVar variants rank in the top 0.1% of all variants within a personal genome, and most rank in the top 1%. About 25% of pathogenic ClinVar SNVs are not scored by PolyPhen or SIFT because of missing values or the restriction of these methods to missense variation; note also that rankings for PolyPhen and SIFT are computed among missense variants only and are therefore derived from far fewer total variants (see a plot restricted to missense variation in FIG. 29). (b) Quantile-quantile plot of C-scores for the SNVs identified in the 11 individual genomes and pathogenic ClinVar SNVs. For a given scaled C-score observed in an individual, the fraction of that individual's variants with a C-score at least that high was computed (y axis). The C-score corresponding to this quantile of the distribution of all possible variants is displayed on the x axis. High C-scores are under-represented compared to the set of all possible variants. In contrast, known disease-causal variants from ClinVar have large C-scores relative to the set of all possible variants. This fact can be exploited to prioritize causal variants identified from whole-genome sequencing of individual genomes as in a (see also FIGS. 32-33).

FIG. 32 is a table showing a number of SNVs observed in whole genome sequencing of eleven human individuals from diverse human populations (Meyer et al. 2012), according to some embodiments. Shown are the numbers of variants with scaled C-scores greater than or equal to the median of the indicated known disease-causal variants. The average scaled C-score for Miller syndrome^{a} is 17, for Freeman-Sheldon syndrome^{b} is 30, for Kabuki sydnrome^{c} is 39, and across all pathogenic ClinVar variants is 23. Putative disease causing alleles are highly ranked in each of the personal genomes. For example, after filtering genome-wide variation from 1000 G at a >1% cutoff, on average only 1066 variants (0.07%) in each genome have a C-score equal or greater to the average C-score of pathogenic ClinVar variants. This can be exploited to efficiently prioritize causal variants in whole genome shotgun experiments.

FIG. 33 is a table showing a number of single nucleotide variants observed per scaled C-score bin, according to some embodiments, in NIH ClinVar pathogenic, the 1000 Genomes low coverage data, derived variants on the Chimpanzee lineage and eleven human individuals from diverse populations (Meyer et al. 2012). The Table also provides the depletion values as plotted in FIG. 17b (1000 G) and c (Chimpanzee).

FIG. 34 is a table showing a comparison of CADD scores between GWAS and matched control SNP sets according to some embodiments.

FIG. 35 shows that C-scores for GWAS SNPs are higher than for nearby control SNPs and are dependent on study sample size according to one embodiment. The average scaled C-score (y axis) is plotted for each category of SNPs, as indicated by color, relative to the sample size of the association study in which the SNP was identified (x axis). Sample size bins are log2 scaled and mutually exclusive; for example, the bin labeled 1,024 represents all SNPs from studies with between 512 and 1,024 samples. Error bars, ±1 s.e.m. Each shaded rectangle represents overall (across all sample sizes) scaled C-score mean±1 s.e.m. for each category as indicated by color.

FIG. 36 shows the relationship of C-scores with the statistical significance of genome wide association studies according to some embodiments.

### DETAILED DESCRIPTION

Provided herein is a general framework and methods for integrating diverse genome annotations and scoring a human genomic variant, e.g., a genetic mutation resulting in a single-nucleotide variant (SNV) (also referred to as a single nucleotide polymorphism (SNP) or an insertion or deletion event (also referred to as an insertion-deletion event or an “indel” event). According to the embodiments described herein, this framework may be implemented by various computer-based methods for determining the relative effect (e.g., pathogenicity or functionality) of a genetic variant using a single metric (or score), and is also referred to as “Combined Annotation—Dependent Depletion”, or CADD. As referred to herein, the term “genetic variant” is any alternation or change to the nucleotide sequence of a gene, genome or any other DNA molecule derived from the genetic material of a human or other organism. Such alternations may include, but are not limited to, single-nucleotide polymorphisms (SNPs), (also referred to herein as a single nucleotide variant, or SNV), insertion or deletion events (or “indels”), and copy number variants. The alternation or change may have no effect, may alter the expression or function of a gene or its expression product, or may prevent the gene or its expression product from functioning properly. Effects caused by genetic variants may be neutral in effect, beneficial in effect, or pathogenic in effect. Genetic variants that are rare and/or abnormal among the population are also known as mutations. Many mutations cause pathogenic changes associated with human diseases (inheritable or non-inheritable), but mutations may also result in neutral or beneficial effects.

The basis of the CADD framework and methods described herein is to contrast a set of annotations for fixed or nearly fixed derived alleles in humans (i.e., observed human derived variants) with those of simulated variants. Deleterious variants—that is, variants that reduce organismal fitness—are depleted by natural selection in fixed but not simulated variation. The CADD framework therefore measures deleteriousness by way of assigning a calculated integrated deleteriousness score to a genetic variant or a set of genetic variants, as described in detail below. Deleteriousness is a property that strongly correlates with both molecular functionality and pathogenicity (Kimura 1983). Metrics of deleteriousness (e.g., an integrated deleteriousness score), in contrast to metrics limited to pathogenicity or molecular functionality, have many advantages for use in genomics field (e.g., clinicians, researchers, patients, etc.). Whereas metrics limited to pathogenicity or molecular functionality are limited in scope to a small set of genetically or experimentally well-characterized mutations and are subject to major ascertainment biases, deleteriousness can be measured systematically across a genome assembly (see Cooper et al. 2005; Siepel et al. 2005; Pollard et al. 2010 and description below). Further, selective constraint on genetic variants is related to the totality of their phenotype-relevant effects rather than to any individual molecular or phenotypic consequence. Measures of deleteriousness can therefore provide, in principle, a genome-wide, data-rich, functionally generic and organismally relevant estimate of variant effect that can be useful across datasets and annotation tools in the field.

### Machine Learning Models

In some embodiments, the methods for determining the relative effect (e.g., pathogenicity or functionality) of a genetic variant may include a step of applying a machine learning model to a dataset. As referred to herein, a “dataset” includes a set of one or more genetic variants and a set of one or more annotations, wherein each of the one or more genetic variants are associated with values or states of each of the one or more annotations. In some aspects, the dataset may be a training set (e.g., a set of observed variants, a set of simulated variants, or both) that, when applied to a machine learning model, trains the machine learning model. In other aspects, the dataset may be a test set (e.g., one or more variants derived from a genome, gene, or other DNA molecule) that may be used in applying a machine learning model. In certain embodiments, the dataset includes a set of one or more genetic variants organized in rows of a table and a set of one or more annotations organized in columns of the table. In other embodiments, the dataset includes a set includes a set of one or more genetic variants organized in columns of a table and a set of one or more annotations organized in rows of the table. In some aspects, said table provides an organizational structure, within which the one or more genetic variants are associated with values or states of each of the one or more annotations. Such associations may form the basis of an annotation matrix that may be used to apply the machine learning models described below in accordance with the embodiments described herein.

Models that are based on a form machine learning are established by constructing systems that can learn from data, rather than follow only explicitly programmed instructions. Several forms of machine learning that are based on learning algorithms are known in the art including, but not limited to, supervised learning, unsupervised learning, reinforcement learning, semi-supervised learning, transduction, learning to learn, and developmental learning. These forms of machine learning give rise to several approaches for generating a machine learning model. Approaches of machine learning that may be used to generate a model in accordance with the embodiments described herein include, but are not limited to, decision tree learning, association rule learning, artificial neural networks, inductive logic programming, support vector machines, clustering, Bayesian networks, reinforcement learning, representation learning, similarity and metric learning, and sparse dictionary learning.

In one aspect, the machine learning model used in the embodiments described herein is a support vector machine (SVM) model (also known as a “classifier”) (see Franc & Sonnenburg 2009, the subject matter of which is hereby incorporated by reference as if fully set forth herein). In machine learning, SVMs are supervised learning models having associated learning algorithms that analyze data and recognize patterns. SVMs are used, for example, for classification and regression analysis. When applied to a given a set of training examples (i.e., “training sets”), each marked as belonging to one of two categories, an SVM training algorithm builds a model that assigns new examples into one category or the other. A SVM model is a representation of the examples as points in space, mapped so that the examples of the separate categories are divided by a line such that on each side, the gap between the line and the points on the side are maximized. In cases where a perfect separation of points from different categories by a line is not possible, the SVM seeks the best possible such line. New examples are then mapped into that same space and predicted to belong to a category based on which side of the line they fall on.

The SVM may be trained using any methods known in the art. In some methods, the SVM is trained to distinguish between a training set that includes a set of simulated variants and a set of observed variants.

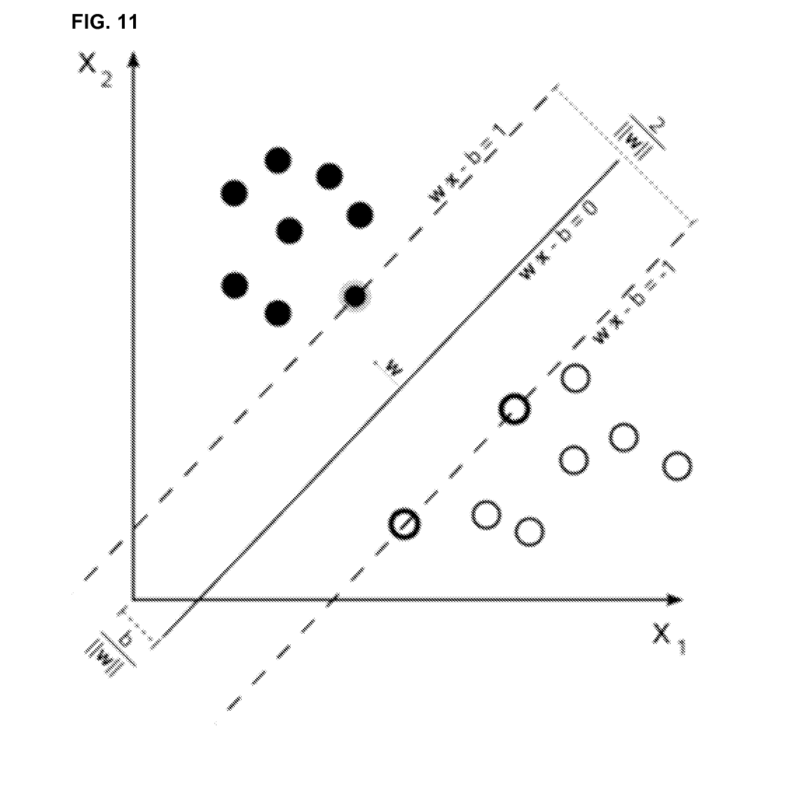

In certain methods, the SVM may be trained using a linear (or non-linear) kernel function (k(x,y)). SVMs are extremely robust classifiers for binary classification problems when the points to be separated are linearly separable. Their utility is extended to nonlinearly separable data by using kernels that implicitly map data to a higher dimension where such data are more likely to be linearly separable. In spaces with more than two dimensions, the term hyperplane is applied, rather than a line, which is a generalization of the notion of a line (see e.g., FIG. 11).

The SVM model may be designed to construct a hyperplane or a set of hyperplanes in a high- or infinite-dimensional space, which can be used for classification, regression, or other tasks. In some aspects, a hyperplane may be defined as the set of points whose dot product with a vector in that space is constant. In this case, the vectors defining the hyperplanes can be chosen to be linear combinations with parameters aᵢ of images of feature vectors that occur in the training set or a test set (or database). In such case, the points x in the feature space that are mapped into the hyperplane are defined by the relation:

$${\sum }_{i} {α}_{i} k ( {x}_{i} , x ) = constant$$

In some embodiments, an SVM model may be trained on features derived from an annotation matrix that includes one or more suitable annotations (e.g., X₁, . . . , Xₙ shown in Function 1 below) used to classify a set of genetic variants of a dataset (e.g., a training set or a test set). Any number of annotations may be used to train the SVM model. The annotations may be derived from one or more annotation tools or pipelines such as AnnoVar, Ensembl Variant Effect Predictor (VEP), snpEffect, Panther, SeattleSeq, FamAnn, RefSeq, GATK VariantAnnotater, VAAST 2.0, Mutalyzer 2, VAT, or any other suitable annotation tool in the art.

In one embodiment, the set of annotations may include, but are not limited to, one or more of: Alt allele, bStatistic, cDNApos, CDSpos, Consequence, Dst2Splice, Dst2SplType, EncExp, EncH3K27Ac, EncH3K4Me1, EncH3K4Me3, EncNucleo, EncOCC, EncOCctcfSig, EncOCDNaseSig, EncOCFaireSig, EncOCmycSig, EncOCpolIISig, GerpN, GerpRS, GerpRSpval, GerpS, Grantham, Indel length, Local CpG density, Local GC density, Mammalian PhastCons, Mammalian PhyloP, minDistTSE, minDistTSS, motifDist, motifECount, motifEHIPos, motifEName, motifEScoreChng, Mutation type, nAA, oAA, PolyPhenCat, PolyPhenVal, Primate PhastCons, Primate PhyloP, protPos, Ref allele, relcDNApos, relCDSpos, relProtPos, Segway, SIFTcat, SIFTval, TFBS, TFBSPeaks, TFBSPeaksMax, tOverlapMotifs, Transversion?, Vertebrate PhastCons, and Vertebrate PhyloP.

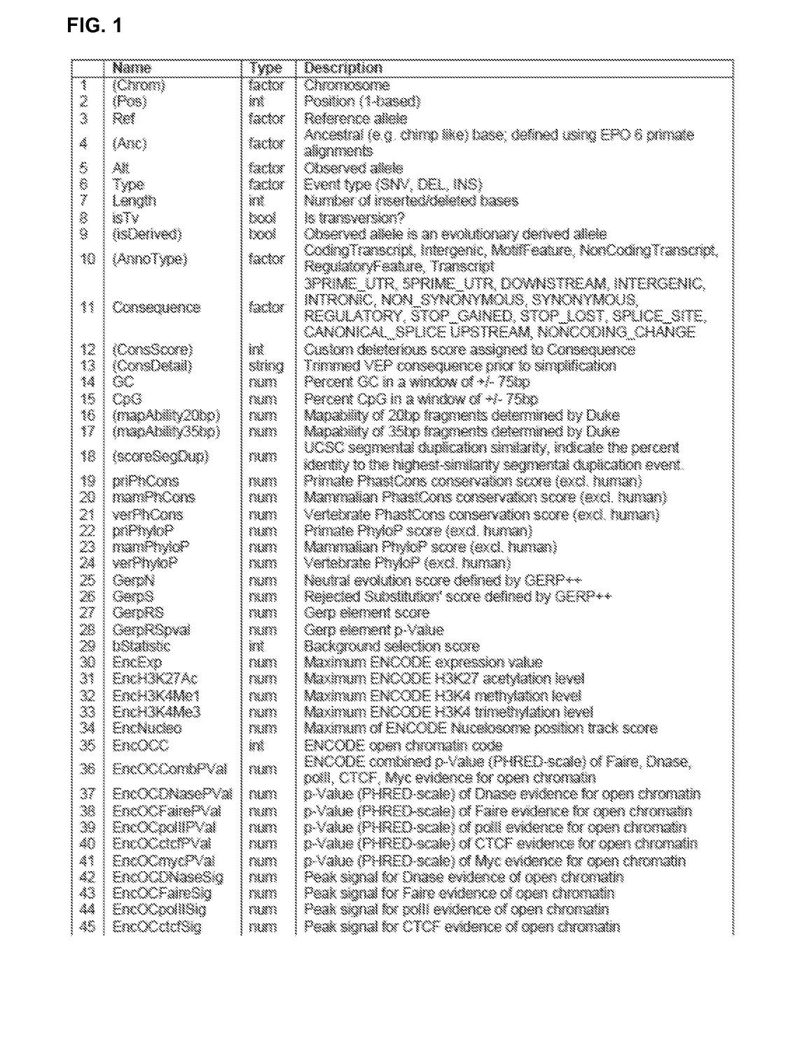

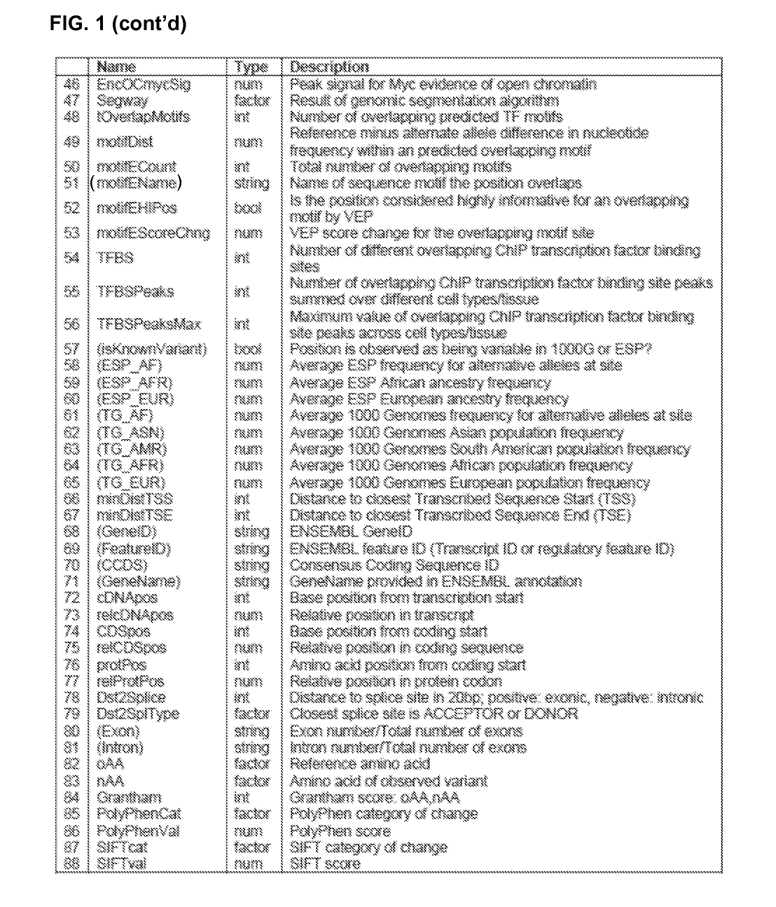

In some aspects, the annotations may be part of or associated with an annotation category. Such categories include, but are not limited to, evolutionary constraint annotations (i.e., conservation metrics) (e.g., Primate PhastCons, Mammalian PhastCons, Vertebrate PhastCons, Primate PhyloP, Mammalian PhyloP, Vertebrate PhyloP, GerpN, GerpS, GerpRS, GerpRSpval, bStatistic); missense annotations (e.g., Grantham, PolyPhenCat, PolyPhenVal, SIFTcat, SIFTval, oAA, nAA); epigenetic measurement annotations (e.g., EncExp, EncH3K27Ac, EncH3K4Me1, EncH3K4Me3, EncNucleo, EncOCC, EncOCDNaseSig, EncOCFaireSig, EncOCpolIISig, EncOCctcfSig, EncOCmycSig); functional prediction annotations (e.g., tOverlapMotifs, motifDist, motifECount, motifEName, motifEHlPos, motifEScoreChng, TFBS, TFBSPeaks, TFBSPeaksMax, Segway); sequence context annotations (e.g., Ref allele, Alt allele, Mutation type, Transversion?, Indel length, Local GC density, Local CpG density); and gene model annotations (e.g., Consequence, minDistTSS, minDistTSE, cDNApos, relcDNApos, CDSpos, relCDSpos, protPos, relProtPos, Dst2Splice, Dst2SplType). The list of annotations and categories of annotations above is non-limiting, as the SVM model described herein may be updated and/or re-trained to include additional annotations including newly discovered alternative annotations. In one embodiment, a set of annotations which includes those described above are shown in FIG. 1 and described in Example 1 below, the references cited therein are hereby incorporated by reference as if fully set forth herein with respect to the values and status of the annotations. However, the set of annotations is not limited to those described herein, as the model is designed such that additional or new annotations may be incorporated into the model framework. A set of new or additional annotations may derived from any suitable source, including and in addition to those described herein.

In one embodiment, an SVM model was trained with a linear kernel on features derived from a number (Xₙ) of annotations, supplemented by a limited number of interaction terms. In one embodiment, the number of annotations is 63 (see FIGS. 1-2, 11-12, and Example 1 below), but the SVM model may be updated to include additional annotations as they become available. In this embodiment, the SVM model is a hyperplane defined by the kernel function shown below (Function 1). In Function 1, X₁, . . . , Xₙ represent each of the annotations (e.g., 63 annotations described in the Examples below, which are expanded from 63 to 166 features due to the treatment of categorical annotations), W₁, . . . , W₁₁ represent the Boolean features that indicate whether a given feature (out of cDNApos, relcDNApos, CDSpos, relCDSpos, protPos, relProtPos, Grantham, PolyPhenVal, SIFTval, as well as Dst2Splice ACCEPTOR and DONOR) is undefined, 1_{{A}} is an indicator variable for whether the event A holds, and D is the set of bStatistic, cDNApos, CDSpos, Dst2Splice, GerpN, GerpS, mamPhCons, mamPhyloP, minDistTSE, minDistTSS, priPhCons, priPhyloP, protPos, relcDNApos, relCDSpos, relProtPos, verPhCons, and verPhyloP. Due to the coding of categorical values using Boolean variables, the total number of features for this model is 949. The hyperplane is defined by Function 1 as follows:

$$0 = {β}_{0} + {\sum }_{i = 1}^{166} {β}_{i} {X}_{i} + {\sum }_{i = 1}^{5} {\sum }_{j = 1}^{5} {γ}_{ij} {1}_{\{ ith Ref category and jth Alt category \}} + {\sum }_{i = 1}^{21} {\sum }_{j = 1}^{21} {δ}_{ij} {1}_{\{ ith oAA category and jth nAA category \}} + {\sum }_{i = 1}^{11} {τ}_{i} {W}_{i} + {\sum }_{i = 1}^{17} {\sum }_{j ∈ D} {α}_{ij} {1}_{\{ ith Consequence category \}} {X}_{j}$$

According to certain embodiments, a set of genetic variants (e.g., those part of a training set or a test set) that may be used for generating annotations, training an SVM or other machine learning model, or applying the SVM or other machine learning model described above, may be derived from any suitable source, such as one or more public variant databases known in the art, or from one or more customized databases that include one or more variants of interest identified by a user (e.g., a researcher or clinician). In some aspects, a set of genetic variants may be derived from a variant database including, but not limited to, Exome Variant Server (EVS), dbSNP (NCBI), dbNSFP, 1000 Genomes (variants deposited in dbSNP), 1000 Genomes (provided through the European Bioinformatics Institute), ENCODE Project, UCSC Genome Browser, COSMIC (Catalogue of Somatic Mutations In Cancer) Project, gwasCatalog (GWAS), refGene, knownGene, ccdsGene, phastCons, cytoBand, keggPathway, or CancerGeneCensus.

In one embodiment, an annotation matrix may be generated using a set of genetic variants derived from the following sources: the Ensembl Variant Effect Predictor (McClaren et al. 2010) (VEP), data from the ENCODE Project (ENCODE Project Consortium et al. 2012) and information from UCSC Genome Browser tracks (Meyer et al. 2013 (FIG. 1). Annotations spanned a range of data types, including conservation metrics such as GERP (Cooper et al. 2005), phastCons (Siepel et al. 2005) and phyloP (Pollard et al. 2010); regulatory information (ENCODE Project Consortium et al. 2012) such as genomic regions of DNase I hypersensitivity (Boyle et al. 2008) and transcription factor binding (Johnson et al. 2007); transcript information such as distance to exon-intron boundaries or expression levels in commonly studied cell lines (ENCODE Project Consortium et al. 2012); and protein-level scores such as those generated with Grantham (Grantham 1974), SIFT (Ng & Henikoff 2003) and PolyPhen (Adzhubei et al. 2010). The resulting variant-by-annotation matrix contained 29.4 million variants (half fixed or nearly fixed human-derived alleles ('observed') and half simulated de novo mutations (‘simulated’)) and 63 distinct annotations, some of which were composites that summarized many underlying annotations (See Example 1 below).

### Integrated Deleteriousness Scores

In some embodiments, the method the methods for determining the relative effect (e.g., pathogenicity or functionality) of a genetic variant may include a step of calculating and/or assigning an integrated deleteriousness score (also referred to herein as “CADD scores” or “C-Scores”) for each of one or more genetic variants of the dataset based on the machine learning model described above.

The integrated deleteriousness score may be a raw integrated deleteriousness score or a scaled integrated deleteriousness score. Integrated deleteriousness scores are useful in at least two distinct forms, namely “raw” and “scaled”. In the embodiments described above, “raw” integrated deleteriousness scores come straight from the SVM, and are interpretable as the extent to which the annotation profile for a given variant suggests that that variant is likely to be “observed” (negative values) vs “simulated” (positive values). These values have no absolute unit of meaning and are incomparable across distinct annotation combinations, training sets, or SVM model parameters. However, raw values do have relative meaning, with higher values indicating that a variant is more likely to be simulated (or “not observed”) and therefore more likely to have deleterious effects.

Since the raw scores do have relative meaning, a specific group of variants may be identified, and the rank for each variant may be defined within that group. The ranked value may then be used as a “normalized” or “scaled” integrated deleteriousness score, which is an externally comparable unit of analysis. In the embodiments described in Example 1 below, all ˜8.6 billion SNVs of a GRCh37/hg19 reference genome were scored and then those values were “PHRED-scaled” by expressing them as rounded, order of magnitude values (with precision increasing for low ranks). For example, reference genome single nucleotide variants at the top 10% of CADD scores are assigned to CADD-10, top 1% to CADD-20, top 0.1% to CADD-30, etc. The results of this transformation are the “scaled” CADD scores.

Raw and scaled integrated deleteriousness scores are useful in different contexts. In one embodiment, raw scores may be used for resolution of genetic variants. For example, raw scores offer superior resolution across the entire spectrum, and preserve relative differences between scores that may otherwise be rounded away in the scaled integrated deleteriousness scores. For example, using the reference genome described in Example 1 below, the bottom 90% (˜7.74 billion) of all GRCh37/hg19 reference SNVs (˜8.6 billion) are compressed into scaled CADD units of 0 to 10, while the next 9% (top 10% to top 1%, spanning ˜774 million SNVs) occupy CADD-10 to CADD-20, etc., with the scaled units only getting close to resolving individual SNVs from one another at the extreme top end. As a result, many variants that have substantive raw score differences between them are rounded to the same or very similar scaled value.

In certain embodiments, a scaled integrated deleteriousness score may be used as a frame of reference e.g., between different reference genes or genomes, different versions of the machine learning models, or different/separate analyses. Since there must always be a top-ranked variant, second-ranked variant, etc., scaled scores are easier to interpret at first glance and will be comparable across different CADD framework versions as, for example, the SVM is updated to include new annotations or use alternative model-building methods. A scaled score of 10, for example, refers to the top 10% of all reference genome SNVs, regardless of the details of the annotation set, model parameters, etc. Furthermore, with scaled values one can always infer, with just a simple glance, the probability of picking a variant(s) at that score or greater when selecting randomly from all possible reference SNVs.

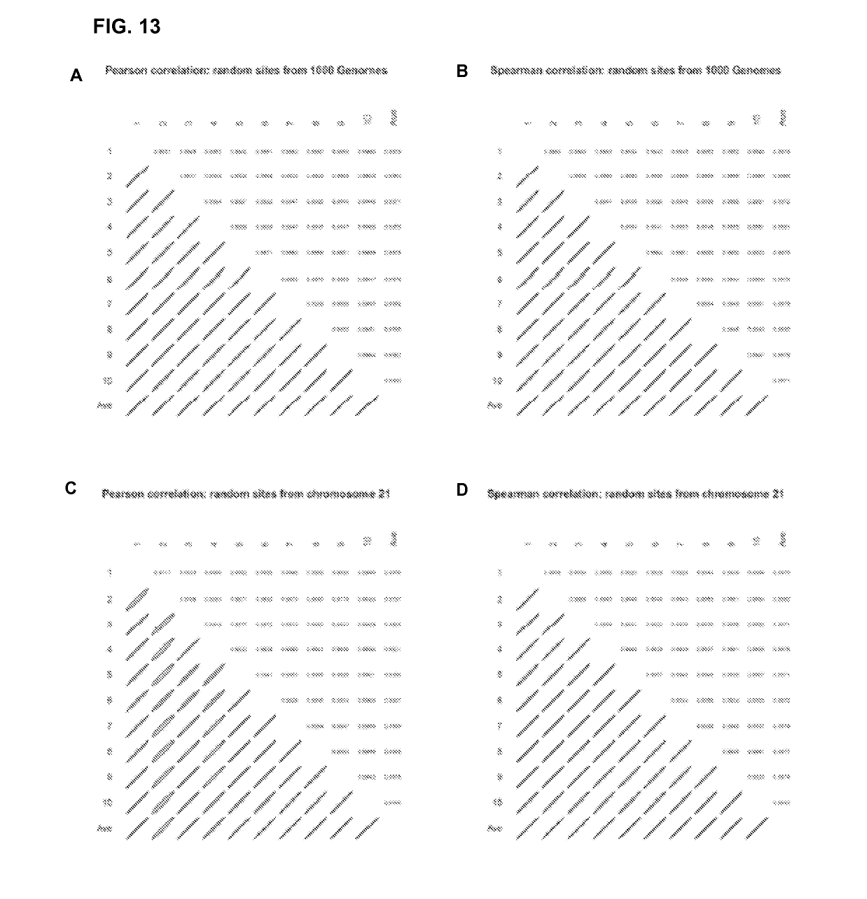

According to one embodiment described in the Examples below, ten SVM models, independently trained on observed variants and different samples of simulated variants, were highly correlated (all pairwise Spearman rank correlations >0.99; FIGS. 13A-13D). An average of these models was applied to assign a raw integrated deleteriousness score (e.g., a C-Score or a CADD score) to all 8.6 billion possible SNVs of the human reference genome (GRCh37). To simplify interpretation in some contexts, phred-like scores (Ewing & Green 1998, the subject matter of which is hereby incorporated by reference as if fully set forth herein) (also referred to herein as “scaled C-scores” or a “scaled integrated deleteriousness score”) were defined on the basis of the rank of the C-score of each variant relative to all 8.6 billion possible SNVs, ranging from 1 to 99 (see Example 1). For example, substitutions with the highest 10% (10₋₁) of all scores—that is, those least likely to be observed human alleles under the model—were assigned values of 10 or greater (‘≧C10’), whereas variants in the highest 1% (10⁻²), 0.1% (10⁻³), etc. were assigned scores ‘≧C20’, ‘≧C30’, etc.

According to the embodiments described herein, the integrated deleteriousness score assigned to a genetic variant may be used to determine its relative effect or effects (e.g., relative pathogenicity or functionality) when compared to other integrated deleteriousness scores. For example, in some embodiments, the integrated deleteriousness score assigned to a genetic variant may be compared to a plurality of integrated deleteriousness scores that are assigned or calculated for a reference gene or genome. In some aspects, the integrated deleteriousness scores for the reference gene or genome are precomputed and are used to provide a reference scoring scheme, within which an integrated deleteriousness score assigned to a genetic variant of interest may fit or be compared. For example, the reference genome described in Example 1 below may include a precomputed set of raw and/or scaled reference universal deleterious scores that may serve as a backdrop reference with which to compare a raw and/or scaled universal deleterious score of a genetic variant of interest. In other embodiments, the integrated deleteriousness score assigned to a genetic variant may be compared to a plurality of integrated deleteriousness scores that are assigned or calculated for a plurality of genetic variants that are part of the same dataset, or part of a different dataset.dataset In one aspect, a genetic variant of interest that is part of a dataset that includes 100 genetic variants, the integrated deleteriousness score of the genetic variant of interest may be compared to the integrated deleteriousness score of the other 99 genetic variants that are part of the dataset. The use of an integrated deleteriousness score is further discussed below.

According to some embodiments, the methods described herein may be used in several applications as follows, depending on the appropriate choice of scores.

In certain embodiments, the methods described herein may be used to discover causal variants within an individual, or small groups, of exomes or genomes. Scaled CADD scores are most useful in this context, as one will generally only be interested or capable of reviewing a small set of the “most interesting” variants. In this setting, the distinction between a variant at the 25th percentile and 75th percentile is effectively irrelevant (scaled scores of ˜0 to 1), while the difference between a variant in the top 10% (scaled score of 10) vs 1% (scaled score of 20) may be quite meaningful. Further, the absolute frame of the reference is valuable here, allowing an analyst to quickly place a variant in context and facilitate easier translation of results across publications, studies, etc.

In certain embodiments, the methods described herein may be used for fine-mapping to discover causal variants within associated loci. As above, scaled scores are likely to be more useful here by allowing focus on a small set of manually reviewable best candidates and providing the absolute frame of the reference genome.

In certain embodiments, the methods described herein may be used to compare distributions of scores between groups of variants, e.g., cases vs controls. In this case, raw scores should be used, as they preserve distinctions that may be relevant across the entire scoring spectrum. Scaled scores may obscure systematic and potentially highly significant distinctions between two groups of variants (e.g., the first and third quartiles of all hg19 SNV scores). Further, since such analyses are generally conducted computationally and without manual intervention, the absolute frame of reference advantage to scaled scores is not as valuable in this context.

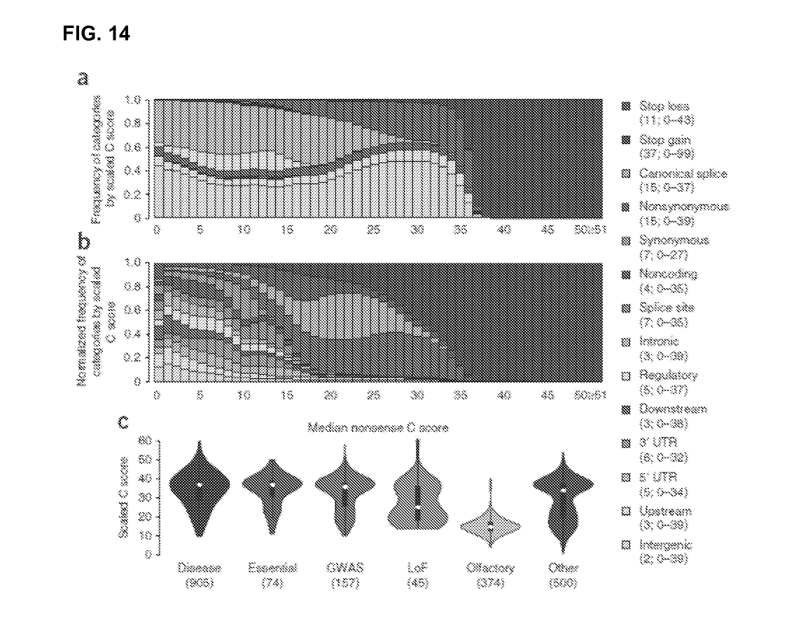

In the analyses presented in the Examples described herein, both types of scores (raw and scaled) were used. For many FIGS. and Tables (e.g. FIG. 14), scaled values were used to ease interpretation and take advantage of the absolute frame of a reference genome provided by GRCh37/hg19. Importantly, one must remember when examining these display items that high scaled values capture a tiny amount of the total universe of human SNVs: for example, there are only ˜86,000 (out of ˜8.6 billion) possible SNVs that score at or above CADD-50 (the maximum used for several FIGS./Tables), and only ˜8.6 million above CADD-30. Since high-scoring variants tend to be deleterious, these thresholds capture even smaller subsets of actually observed variants. For all distributional analyses, such as contrasting CADD scores between disease and benign variant sets, case and control exomes, associated and non-associated SNPs, raw scores were used to take advantage of their higher resolution.

### Computer Systems and Software

The methods described herein may be used in the context of a computer system or as part of software or computer-executable instructions that are stored in a computer-readable storage medium.

In some embodiments, a system (e.g., a computer system) may be used to implement certain features of some of the embodiments of the invention. For example, in certain embodiments, a system (e.g., a computer system) for generating an integrated deleteriousness score is provided. The integrated deleteriousness score generated by the system may be used to determine the relative effect (e.g., the relative pathogenicity) of a genetic variant in accordance with the features of the embodiments described above.

In certain embodiments, the system may include one or more memory and/or storage devices. The memory and storage devices may be one or more computer-readable storage media that may store computer-executable instructions that implement at least portions of the various embodiments of the invention. In one embodiment, the system may include a computer-readable storage medium which stores computer-executable instructions that include, but are not limited to, one or both of the following: (i) instructions for applying a machine learning model to a dataset including one or more genetic variants, each of which is associated with values or states of each of a set of annotations; and (ii) instructions for calculating and/or assigning an integrated deleteriousness score to each of one or more genetic variants. Such instructions may be carried out in accordance with the methods described in the embodiments above.

In certain embodiments, the system may include a processor configured to perform one or more steps including, but not limited to, (i) receiving a dataset (e.g., a set of genetic variants and associated annotation data entered or uploaded by a user); and (ii) executing a set of computer-executable instructions stored in a computer-readable storage medium, such as that described above. The steps may be performed in accordance with the methods described in the embodiments above.

The computer system may be a server computer, a client computer, a personal computer (PC), a user device, a tablet PC, a laptop computer, a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, wearable device, or any machine capable of executing a set of instructions, sequential or otherwise, that specify actions to be taken by that machine.

The computing system may include one or more central processing units (“processors”), memory, input/output devices, e.g. keyboard and pointing devices, touch devices, display devices, storage devices, e.g. disk drives, and network adapters, e.g. network interfaces, that are connected to an interconnect.

According to some aspects, the interconnect is an abstraction that represents any one or more separate physical buses, point-to-point connections, or both, connected by appropriate bridges, adapters, or controllers. The interconnect, therefore, may include, for example a system bus, a peripheral component interconnect (PCI) bus or PCI-Express bus, a HyperTransport or industry standard architecture (ISA) bus, a small computer system interface (SCSI) bus, a universal serial bus (USB), IIC (12C) bus, or an Institute of Electrical and Electronics Engineers (IEEE) standard 1394 bus, also referred to as Firewire.

In addition, data structures and message structures may be stored or transmitted via a data transmission medium, e.g. a signal on a communications link. Various communications links may be used, e.g. the Internet, a local area network, a wide area network, or a point-to-point dial-up connection. Thus, computer readable media can include computer-readable storage media, e.g. non-transitory media, and computer-readable transmission media.

The instructions stored in memory can be implemented as software and/or firmware to program one or more processors to carry out the actions described above. In some embodiments of the invention, such software or firmware may be initially provided to the processing system by downloading it from a remote system through the computing system, e.g. via the network adapter.

The various embodiments of the invention introduced herein can be implemented by, for example, programmable circuitry, e.g. one or more microprocessors, programmed with software and/or firmware, entirely in special-purpose hardwired, i.e. non-programmable, circuitry, or in a combination of such forms. Special purpose hardwired circuitry may be in the form of, for example, one or more ASICs, PLDs, FPGAs, etc.

### Advantages of the Embodiments

The CADD methods described herein provide a generic, expandable framework that may be used for integrating information contained in diverse annotations of genetic variation into a single score. It was demonstrated that in a variety of contexts this approach is better than other widely used annotations prioritizing functional and pathogenic variants (see Examples below). Further, beyond usefulness in any one setting, there are practical and conceptual advantages to CADD that provide significant value to genetic studies of human disease for at least the following reasons. First, the information content of many individual annotations is objectively merged into a single value, which is far preferable to ad hoc approaches for combining annotations and is likely to improve performance, consistent with the benefits seen for consensus methods in missense mutation—specific annotation (Gonzalez-Perez & Lopez-Bigas 2011). Second, the CADD framework can readily be updated to incorporate expansions to existing annotations and entirely new annotations. This ability to indefinitely and readily integrate new information is crucial in light of annotation tools and projects such as ENCODE, which are continuously and rapidly expanding available annotations (ENCODE Project Consortium et al. 2012). Third, the CADD framework combines the generality of conservation-based metrics with the specificity of subset-relevant functional metrics (for example, PolyPhen), exploiting the advantages of both approaches while attenuating their respective disadvantages.

The one-stop nature of CADD confers practical and conceptual value to future sequencing studies. It will minimize the scope and diversity of annotations that have to be generated, tracked and evaluated by a laboratory or project and will reduce the need for ad hoc combinations of filters, scores and parameters as is now routinely carried out. For example, a standard approach in exome studies is to merge missense (with or without an annotation of damaging or a given level of conservation), nonsense and splice-disrupting variants into a single, internally unranked list of protein-altering variants before genetic analysis (Ng et al. 2009). With CADD, one might avoid arbitrary filters or thresholds altogether, including both coding and noncoding variants on a single, meaningfully ranked list. For example, a recent study of recessive, non-syndromic pancreatic agenesis identified five causal noncoding variants that disrupted the function of a distal enhancer of PTF1A (Weedon et al. 2014). C-scores for these noncoding, disease-causal variants (scaled scores between 23.2 and 24.5) rank them higher than 99.5% of all possible human SNVs, higher than 97% of missense SNVs in a typical exome and higher than 56% of pathogenic SNVs in ClinVar (Baker 2012).

In research and in the clinic, the capacity to define catalogs of genetic variants currently exceeds the ability to systematically evaluate their potential effects. This disparity will deepen as sequencing accelerates, genomes displace exomes and the array of functional categories and annotations expands. As a solution, a unified, quantitative and scalable framework (such as the CADD framework described herein) that is capable of exploiting many genomic annotations may be used to meet the challenge posed. Thus, the model, methods, and systems described herein are broadly useful, and will improve over time with updates, allowing for better interpretation of variants of uncertain significance in a clinical setting and improving discovery power for genetic studies of both Mendelian and complex diseases.

The following examples are intended to illustrate various embodiments of the invention. As such, the specific embodiments discussed are not to be construed as limitations on the scope of the invention. It will be apparent to one skilled in the art that various equivalents, changes, and modifications may be made without departing from the scope of invention, and it is understood that such equivalent embodiments are to be included herein. Further, all references cited in the disclosure are hereby incorporated by reference in their entirety, as if fully set forth herein.

### EXAMPLES

### Example 1

### Implementation of a General Framework for Determining the Relative Pathogenicity of Human Genetic Variants

A. Simulated and Observed Variants

The basis of the CADD framework is to capture correlates of selective constraint as manifested in differences between two datasets: (1) simulated events generated using parameters estimated from whole genome species alignments, which contain some proportion of deleterious alleles, and (2) species differences that underwent many generations of mostly purifying/negative selection and are depleted for deleterious alleles.

Simulated variants. A genome-wide simulator of de novo germline variation was developed in accordance with the methods and embodiments described herein. Differences between human genomes and the inferred human-chimpanzee ancestral genome (Paten et al. 2008a) where humans carry a derived allele with a frequency of at least 95% (14.9 million SNVs and 1.7 million indels) were identified. Nearly all of these events are fully fixed in the human lineage, with fewer than 5% appearing as nearly fixed polymorphisms in the 1000 Genomes Project (1000 Genomes Project Consortium et al. 2012) variant catalog (derived allele frequency (DAF) ≧95%). The simulator is partially based on the parameters of the General Time Reversible (GTR) model (Tavaré 1986), but because the standard GTR does not naturally accommodate asymmetric CpG-specific mutation rates, a fully empirical model of sequence evolution with a separate rate for CpG dinucleotides and local adjustment of mutation rates (on a 1-Mb scale) was used to simulate de novo mutations. Simulation parameters were obtained from Ensembl Enredo-Pecan-Ortheus (EPO) (Paten et al. 2008b; Paten et al. 2008a) whole genome alignments of six primate species (Ensembl Compara release 66). Using a custom script, an inferred human-chimpanzee ancestor was compared with its aligned human reference sequence (GRch37) to obtain a genome-wide substitution rate matrix, local mutation rate estimates in blocks of 100 kb, and frequency and length distribution of insertion and deletion events.

These parameters were applied to simulate single nucleotide variants (SNV, also referred to as single nucleotide polymorphisms, or SNPs) and insertion/deletion (also referred to herein as “indel”) variants based on the human reference sequence (GRCh37). Variants were simulated by iterating through all bases of the human reference autosomes and the X chromosome and picking sites for mutation with probabilities corresponding to the genome-wide substitution rate matrix. The Y chromosome and additional contigs were not included in this embodiment to exclude effects due to variation in sequence quality. The implementation of the simulator uses a predefined approximate number of mutations, including the relative rates of substitutions and indels based on the EPO alignments. Further, it locally adjusts the overall mutation rate based on the local mutation rate estimated by averaging over the five 100 kb blocks up- and downstream of the site as well as the block of the actual site (i.e. a 1.1 Mb sliding window). Using an approximate number of 40 million autosomal and 2 million X-chromosomal mutations, a total of 46,735,302 SNVs, 2,227,688 insertions (1 to 50 bp) and 3,291,250 deletions (1 to 50 bp) were simulated. The simulated variants were limited to genomic regions for which an inferred human-chimpanzee ancestor sequence is available from the EPO alignments in this embodiment; this reduced the final numbers to 44,182,238 SNVs, 2,108,268 insertions and 3,116,551 deletions. These are referred to as “simulated variants”.

Observed variants. For observed human-derived changes, sites at which the human reference genome differs from the inferred human-chimp ancestral genome were extracted from the Ensembl EPO. This resulted in six primate alignments defined above, excluding variants in the most recent 1000 Genomes Project data (1000 Genomes Project Consortium et al. 2012, variant release 3) with a frequency of greater than 5%, and including variants where the human reference carries an ancestral allele (i.e. matching the inferred human-chimp ancestor sequence) but where the derived allele is observed with frequency above 95% in the 1000 Genomes project data. Low frequency derived variants (average derived allele frequency (DAF) less than 95%) were excluded in order to guarantee that alleles were exposed to many generations of natural selection. A total of 14,893,290 SNVs, and 627,071 insertions and 1,107,414 deletions (less than 50 bp in length) were identified. This set of variants is referred to herein as “HCdiff variants” or “observed variants”. It is noted that even though high frequency derived alleles that are not fully fixed were included, they constitute a small proportion of the observed variants; 99.37% of indels and 95.41% of SNVs in the set of observed variants are invariant in 1000G data.

B. Variant Annotation Matrix

The Ensembl Variant Effect Predictor (VEP, Ensembl Gene annotation v68) (McLaren et al. 2010) was used to obtain gene model annotation for single nucleotide and indel variants. For single nucleotide variants (SNVs) within coding sequence, SIFT (Ng & Henikoff 2003) and PolyPhen-2 (Adzhubei et al. 2010) scores from VEP were also obtained. Output lines describing MotifFeatures were combined with the other annotation lines, reformatted it to a pure tabular format and reduced the different Consequence output values to the following 17 levels: 3PRIME_UTR, 5PRIME_UTR, DOWNSTREAM, UPSTREAM, INTERGENIC, INTRONIC, NONCODING_CHANGE, SYNONYMOUS, NON_SYNONYMOUS, REGULATORY, CANONICAL_SPLICE, SPLICE_SITE, STOP_GAINED, STOP_LOST, INFRAME, FRAME_SHIFT, and UNKNOWN. For training, a 4-level hierarchy was implemented in the case of overlapping annotations. This hierarchy is as follows: if multiple VEP annotation lines were reported for the same variant (due to overlapping annotations), the most deleterious were selected based on the following ranking scheme: (1) VEP effect Sequence Ontology annotation containing substrings “coding”, “missense”, “synonymous”, “stop”, “mature”, “splice”, “initiator_codon”, “frame”, or “terminal_codon”, (2) Sequence Ontology annotations containing “utr” or “regulatory”, (3) Sequence Ontology annotations containing “intronic”, “upstream”, or “downstream”, (4) everything else. A random annotation was selected if multiple lines with the same priority were observed.

To the 6 VEP input derived columns (chromosome, start, reference allele, alternative allele, variant type: SNV/INS/DEL, length) and 26 actual VEP output derived columns, 56 columns were added that contain the following annotations: the ancestral primate allele as obtained from the EPO six primate alignments; a Boolean column indicating whether the ancestral allele is different from the alternative allele; a Boolean column indicating whether the base substitution is a transition or transversion; the Duke University mapability score of 20 bp and 35 bp sequences as distributed by UCSC (Rosenbloom et al. 2012); segmental duplication annotation as provided by UCSC (Fujita et al. 2011); PhastCons and phyloP conservation scores (Hubisz et al. 2011) for primate, mammalian and vertebrate multi-species alignments—all determined starting from UCSC whole genome alignments (Siepel et al. 2005) but excluding the human reference sequence in score calculation; GERP++ (Davydov et al. 2010) N/S and region scores/p-values; the background selection score (original coordinates transferred from NCBI36 to GRCh37) (Meyer et al. 2012; McVicker et al. 2009); the maximum expression value, maximum H3K27 acetylation peak, maximum H3K4 methylation peak, maximum H3K4 trimethylation peak and maximum value in the nucleosome occupancy tracks provided for ENCODE cell lines in the UCSC super tracks (Rosenbloom et al. 2012); maximum peaks and p-values from the Encode open chromatin UCSC track (includes Faire, Dnase, Poll!, CTCF, Myc values as well as two summary scores) (Rosenbloom et al. 2012); the genomic segment type assignment obtained from clustering of ENCODE features (Segway (Hoffman et al. 2012)); the total number of predicted transcription factor (TF) binding sites and the difference in base composition^{b} from the reference allele to the alternative allele for TF binding motifs (ENCODE Project Consortium et al. 2012); the number of different overlapping ENCODE transcription factors; the number and maximum peak of all overlapping ENCODE ChIP-seq transcription factor binding sites in different cell/tissue types (ENCODE Project Consortium et al. 2012) (UCSC EncodeAwgTfbsUniform tracks excluding transcriptions factors already used in open chromation track); a Boolean column indicating whether this site is observed in the above described 1000 Genome variants or the Exome Sequencing Project (ESP) variants (Tennessen et al. 2012); the average allele frequency in 1000 Genomes and the average allele frequency in 1000 Genomes limited to Asian populations, limited to South American population, limited to African populations, and limited to European populations; the average alternative allele frequency in ESP and the average alternative allele frequency in ESP for individuals of African ancestry and individuals of European ancestry; the distance to the closest transcribed sequence start (TSS) and transcribed sequence end (TSE) position in the Ensembl v68 transcript annotation; the distance to the next splice site if 20 bp upstream or downstream, in which case it is also indicated whether this site is approached from within an exon or intron and whether it is a splice acceptor or donor site; and finally the Grantham score (Grantham 1974) associated with a reported amino acid substitution. FIG. 1 lists all columns of the obtained annotation matrix.

If position values (cDNApos, CDSpos, protPos) for indels were provided as value ranges by VEP, the first value reported for the interval was selected. For the additional annotations, the most extreme value was extracted across the positions impacted by an indel event (i.e. all deleted bases for deletions and the base before and after the event for insertions).

C. Imputation and Final Training Data Set

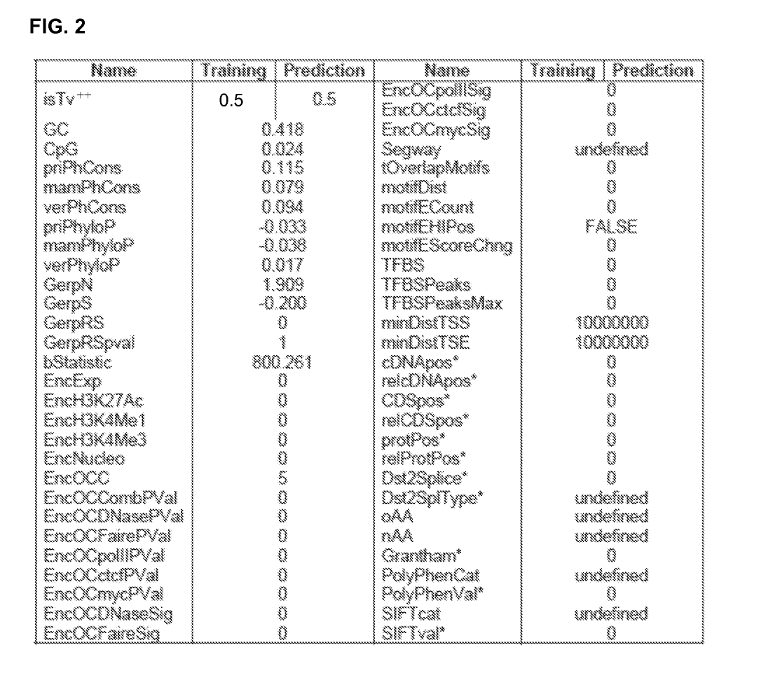

From the annotation described above, some columns are not useful for model training (Chrom, Pos, AnnoType, ConsScore, ConsDetail, motifEName, GeneID, FeatureID, CCDS, GeneName, Exon, Intron) or need to be excluded from training as they will differ between the simulated variants and the human-chimpanzee ancestor differences for technical reasons (Anc, isDerived, mapAbility20 bp, mapAbility35 bp, scoreSegDup, known variation status and ESP/1000G frequency information). Importantly, no allele frequency information was used in model training. In order to fit models, missing values in the remaining annotations must be imputed. Missing values in genome-wide measures were imputed by the genome average obtained from the simulated data, or set missing values to 0 where appropriate (FIG. 2). Further, an “undefined” category was created for the categorical annotations (Segway, oAA, nAA, PolyPhenCat, SIFTcat, Dst2SplType) in order to accommodate missing values. To deal with missing values in annotations that are not defined on a subset of variants (cDNApos, relcDNApos, CDSpos, relCDSpos, protPos, relProtPos, Grantham, PolyPhenVal, SIFTvaI, as well as Dst2Splice ACCEPTOR and DONOR), the missing values were set to zero (0) and indicator variables were also created that contained a 1 if the corresponding variant is undefined, and a 0 otherwise. Because insertions and deletions may produce arbitrary length Ref/Alt and variant(nAA)/reference(oAA) amino acid (AA) sequence columns (and thus not a fixed number of categorical levels), these values were set to N for Ref/Alt and set to “undefined” for nAA/oAA.

When extracting differences between the human-chimp ancestor and present-day human alleles, a deletion from the ancestor is described as an insertion into the human reference; the same applies when describing mutations from the ancestor; they are thus oriented back in time. In contrast, the simulation contains forward mutations of the human reference. To correct this effect, Ref/Alt and nAA/oAA columns were interchanged for HCdiff. For the same reasons, INS/DEL levels in the Type column and STOP_GAINED/STOP_LOST levels in the Consequence column were interchanged for the HCdiff variants before training.

Sites from the simulation were labeled +1 and human derived variants (i.e., sites identified from HCdiff) −1. Only insertions and deletions shorter than 50 bp were considered for model training and the Length column was capped at 49 for the prediction of longer events. The ratio of indel events to SNV events observed for the simulation (1:8.46) was also set for HCdiff by sampling an equal number of variants for both data sets: 13,141,299 SNVs, 627,071 insertions and 926,968 deletions each.

D. Exploratory Analysis of Annotations

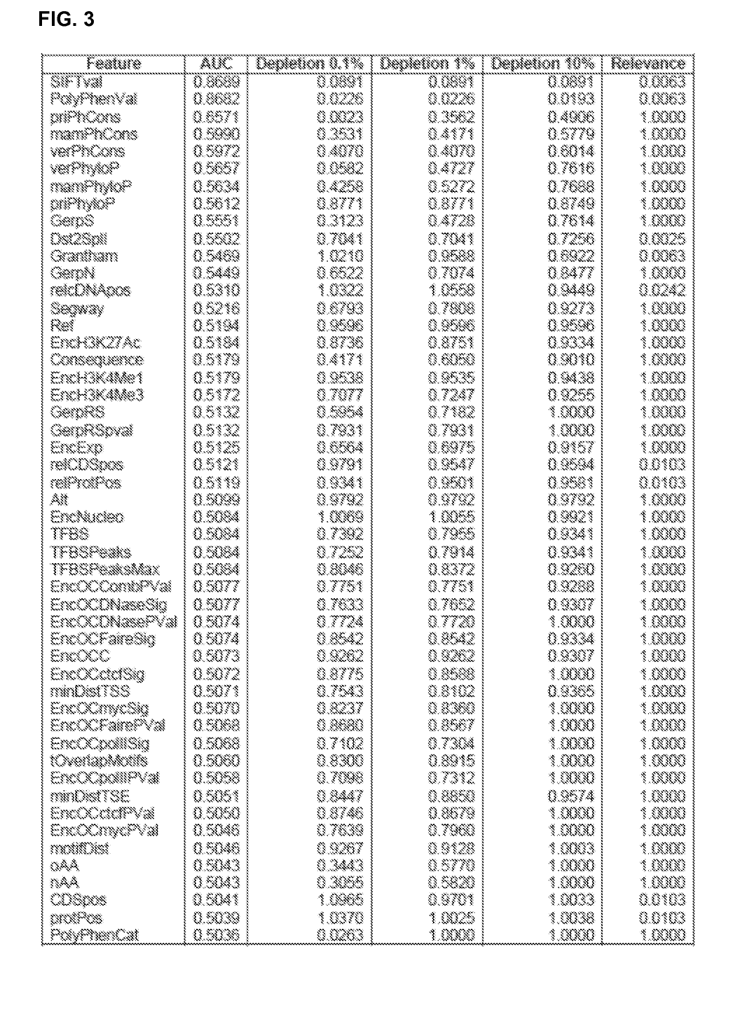

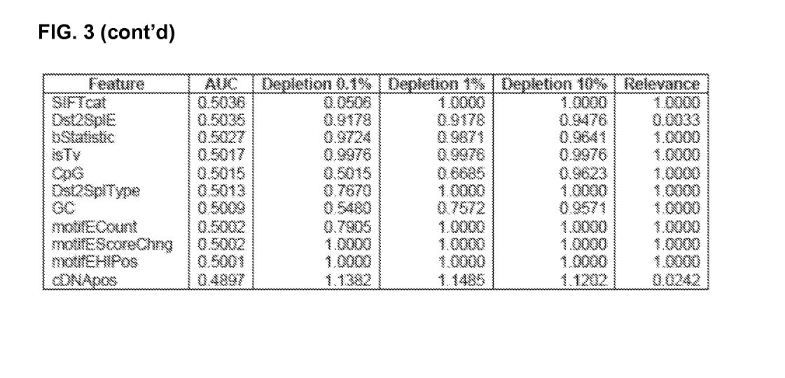

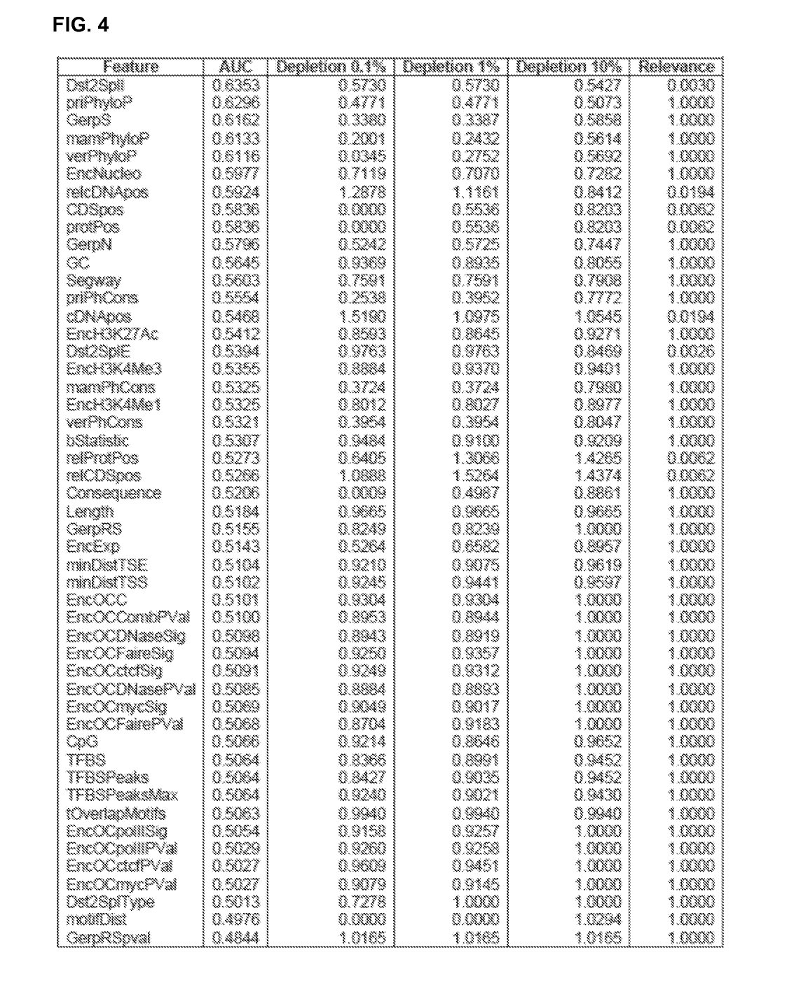

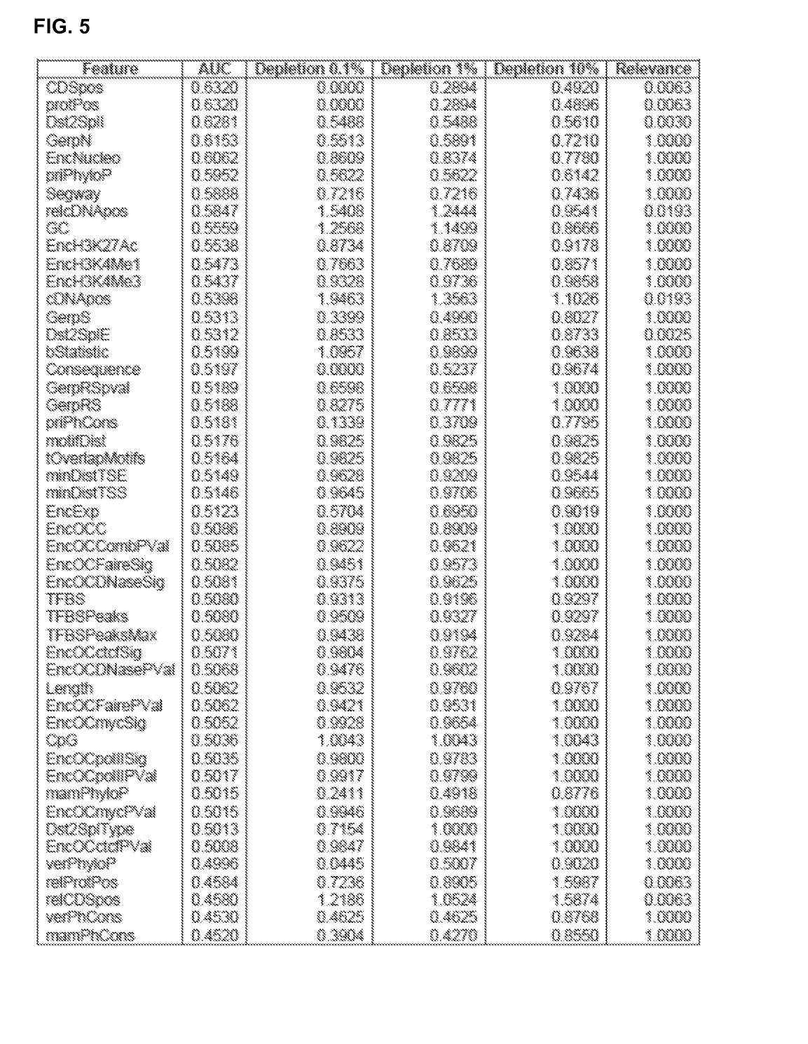

Univariate analyses of SNVs, insertions, and deletions. The following analyses were performed separately on the SNVs, insertions, and deletions. The variants were split into equally-sized training and test sets. For each feature, a univariate logistic regression model was fit on the training set in order to predict whether a site is observed or simulated using just that feature. Test set performance was evaluated using (1) area under the curve (AUC), which is equivalent to a Mann-Whitney U-statistic, and which quantifies the extent to which simulated sites are given higher predictions of deleteriousness than observed sites; and (2) depletion of observed sites among the 0.1%, 1%, and 10% of sites predicted to be most deleterious. An AUC of 0.5 is expected by chance, and an AUC near 1 indicates a model that successfully assigns higher predictions of deleteriousness to simulated sites than to observed sites. Depletion is defined as (fraction of observed sites among the x % predicted to be most deleterious)/(fraction of observed sites in the full data set); a value of 1 is expected by chance, and a small value indicates that the sites predicted to be most deleterious are predominantly simulated. Results are given in FIGS. 3-5.

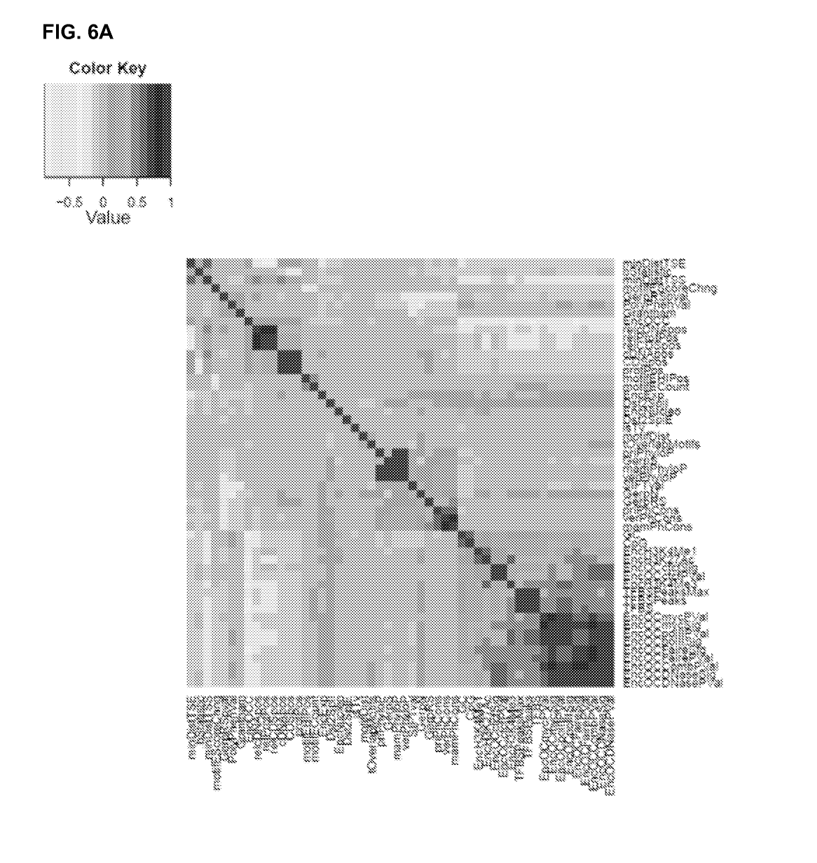

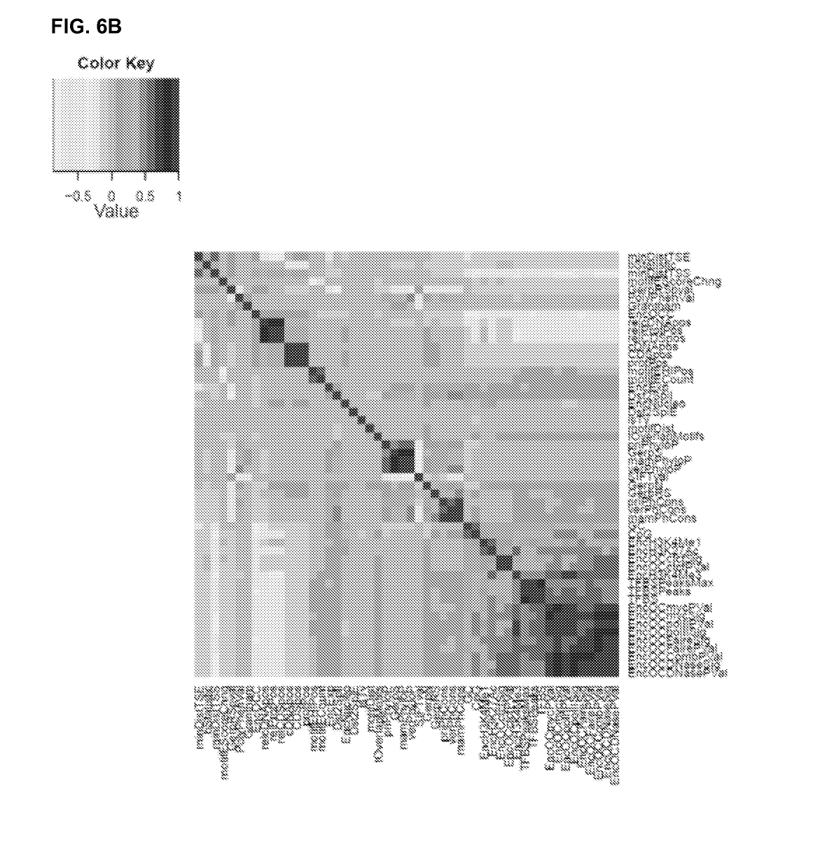

Correlations among quantitative features. FIGS. 6A & 6B display the correlations among the quantitative features in the observed and simulated SNV variants. There are very high levels of correlation within ENCODE annotations, conservation metrics, or the annotations that quantify a variant's position in the cDNA, CDS, or protein.

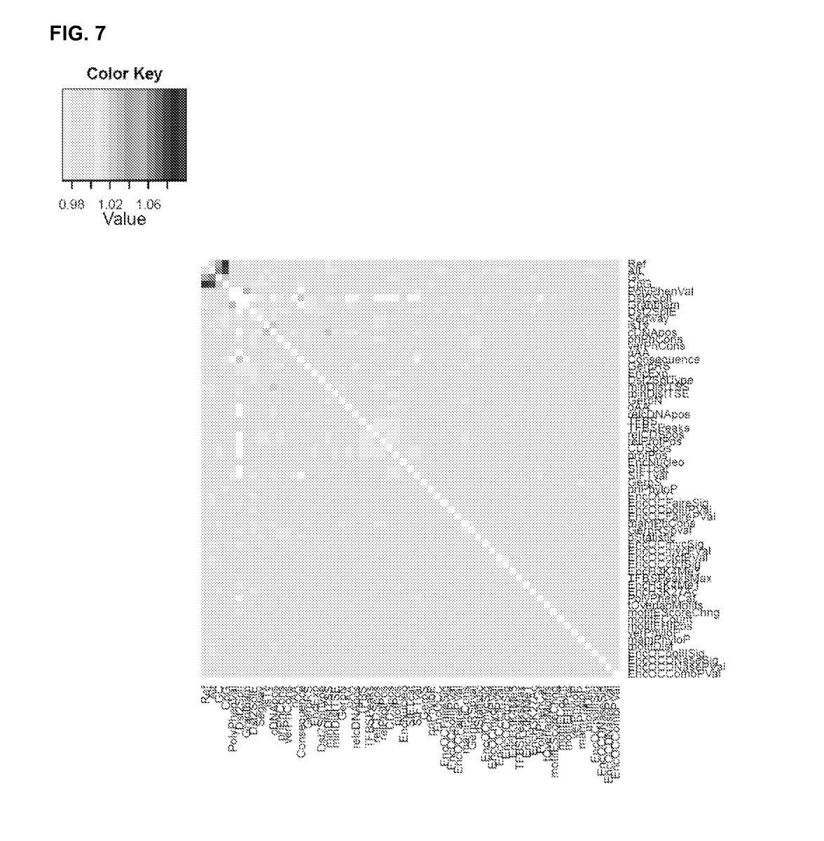

Interactions among features. To determine if predictions of whether a SNV is observed or simulated could be improved by including interactions in the model. For each pair of features x₁ and x₂, linear regression was used to fit a main effects model of the form y˜x₁+x₂, as well as an interaction model of the form y˜x₁+x₂+x₁x₂. Here y is a vector that encodes whether each variant is observed or simulated. FIG. 7 displays the ratio of AUC for the interaction models to the AUC for the main effects models. Few of the interactions yielded a substantial improvement to the AUC relative to the main effects models.

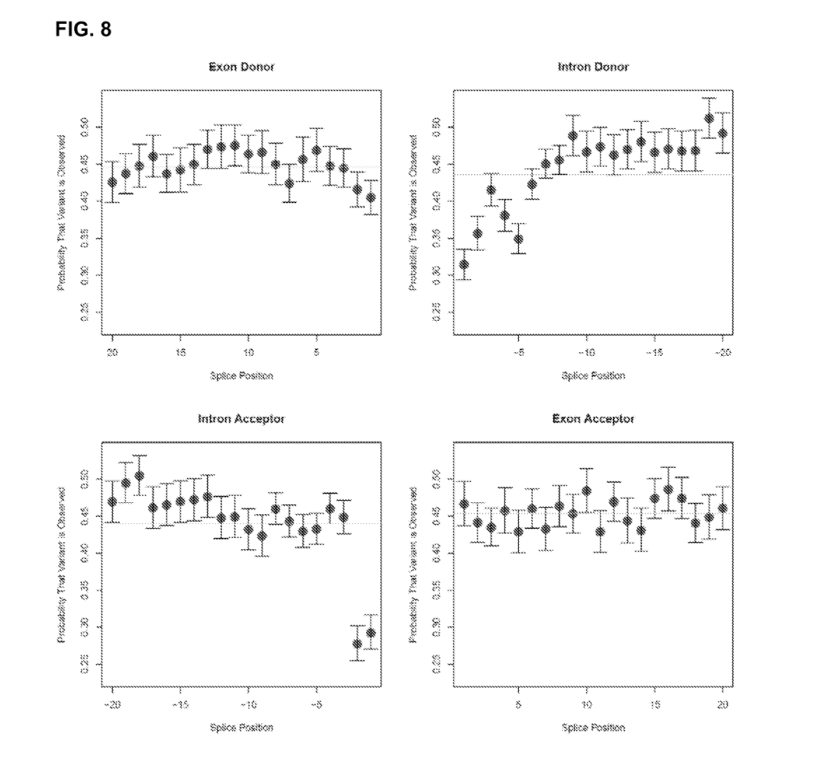

Distance to splice sites. Logistic regression models were fit to predict whether a SNV is observed or simulated, using its distance from splice site (treated as a categorical variable) for sites in the exon donor, intron donor, intron acceptor, and exon acceptor regions. Variants within 20 bp of a splice site that were neither non-synonymous, stop-gain, nor stop-loss events were included. FIG. 8 displays the probability that a variant is observed (as opposed to simulated) given its splice position. The results indicate that variants located in the intron near splice sites are more likely to be simulated rather than observed; this is consistent with the notion that mutations in this region tend to be deleterious. There is clear evidence for preserving the canonical splice sites (i.e. the two intronic basepairs of splice donor and acceptor); in addition it was seen that, for example, multiple additional sites at the intron donor site are highly constrained.

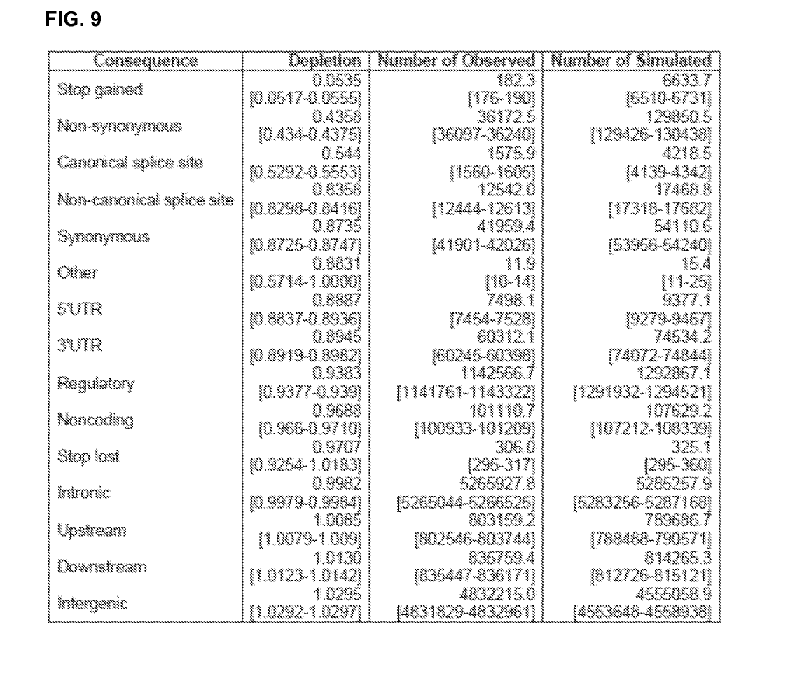

Depletion of observed sites by Consequence. For each consequence bin, the depletion of observed SNVs in that bin was computed: namely, (fraction of sites in that bin that are observed)/(fraction of all sites that are observed). Results are shown in FIG. 9. The “stop-gained” bin is extremely depleted for real sites, as is the “non-synonymous” bin. “Synonymous”, “(canonical) splice site”, “3′UTR”, and “5′UTR” are also depleted. Only the “upstream”, “downstream”, and “intergenic” bins are enriched for observed variants.

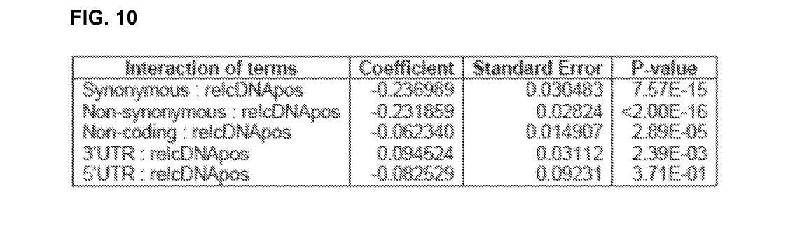

Interaction between Consequence and position of mutation in cDNA. In order to determine whether the deleteriousness of a given Consequence is associated with the SNV's position within the cDNA, a logistic regression model was fit to predict whether a SNV is observed or simulated on the basis of Consequence, relcDNApos, and an interaction between the two. Results are shown in FIG. 10. Synonymous, 5′UTR, non-coding, and non-synonymous SNVs are less likely to be deleterious when they occur later in the cDNA, whereas the opposite is true for 3′UTR mutations.

Summary. The validity of the general approach was first assessed by constructing a series of univariate models described above that contrast observed and simulated variants using each of the 63 annotations as individual predictors. Nearly all models were highly predictive for distinguishing observed and simulated variants (FIGS. 3-5) and were consistent with expectation. For example, a nearly 20-fold depletion of nonsense variants, a 2-fold depletion of missense variants and no depletion of intergenic or upstream or downstream variants were found (FIG. 9). Nonsense and missense mutations that occurred near the start sites of coding DNA were more depleted than those occurring near the ends (FIG.10), and variants within 20, and especially within 2, nucleotides of splice junctions were also depleted (FIG. 8). The best-performing individual annotations were protein-level metrics such as PolyPhen (Adzhubei et al. 2010) and SIFT (Ng & Henikoff 2003), but these evaluated only missense variants (0.63% of all variants in the training data are missense; of these, 88% had defined PolyPhen values and 90% had defined SIFT values). Conservation metrics were the strongest individual genome-wide annotations (FIG. 3).

In addition, correlations between annotations (FIGS. 6A & 6B) and the value of adding interaction terms between annotations (FIG. 7) were examined. Many annotations were correlated, and many interactions had area under the curve (AUC) values above 0.5, but only a handful of interacting pairs meaningfully improved a simple additive model.

Overall, the analyses described above demonstrate that substantial biological differences are present between the observed and simulated variants with respect to the 63 annotations and that linear models capture much of this information.

E. Model Training

Ten training data sets were generated by sampling an equal number of 13,141,299 SNVs, 627,071 insertions and 926,968 deletions from both the simulated variant and observed variant datasets. To train each support vector machine (SVM) model, the processed data was converted to a sparse matrix representation after converting all n-level categorical values to n individual Boolean flags. 1% of sites (˜132,000 SNVs, 6,000 insertions and 9,000 deletions each) were randomly selected and used as a test data set. All other sites were used to train linear SVMs using the LIBOCAS v0.96 library (Franc & Sonnenburg 2009).

The SVM model fits a hyperplane as defined below (Function 1). X₁, . . . , Xₙ represent the 63 annotations described above (which are expanded from 63 to 166 features due to the treatment of categorical annotations), W₁, . . . , W₁₁ represent the Boolean features that indicate whether a given feature (out of cDNApos, relcDNApos, CDSpos, relCDSpos, protPos, relProtPos, Grantham, PolyPhenVal, SIFTval, as well as Dst2Splice ACCEPTOR and DONOR) is undefined, 1_{{A}} is an indicator variable for whether the event A holds, and D is the set of bStatistic, cDNApos, CDSpos, Dst2Splice, GerpN, GerpS, mamPhCons, mamPhyloP, minDistTSE, minDistTSS, priPhCons, priPhyloP, protPos, relcDNApos, relCDSpos, relProtPos, verPhCons, and verPhyloP. Due to the coding of categorical values using Boolean variables, the total number of features for this model is 949. The hyperplane is defined by Function 1 as follows:

$$0 = {β}_{0} + {\sum }_{i = 1}^{166} {β}_{i} {X}_{i} + {\sum }_{i = 1}^{5} {\sum }_{j = 1}^{5} {γ}_{ij} {1}_{\{ ith Ref category and jth Alt category \}} + {\sum }_{i = 1}^{21} {\sum }_{j = 1}^{21} {δ}_{ij} {1}_{\{ ith oAA category and jth nAA category \}} + {\sum }_{i = 1}^{11} {τ}_{i} {W}_{i} + {\sum }_{i = 1}^{17} {\sum }_{j ∈ D} {α}_{ij} {1}_{\{ ith Consequence category \}} {X}_{j}$$

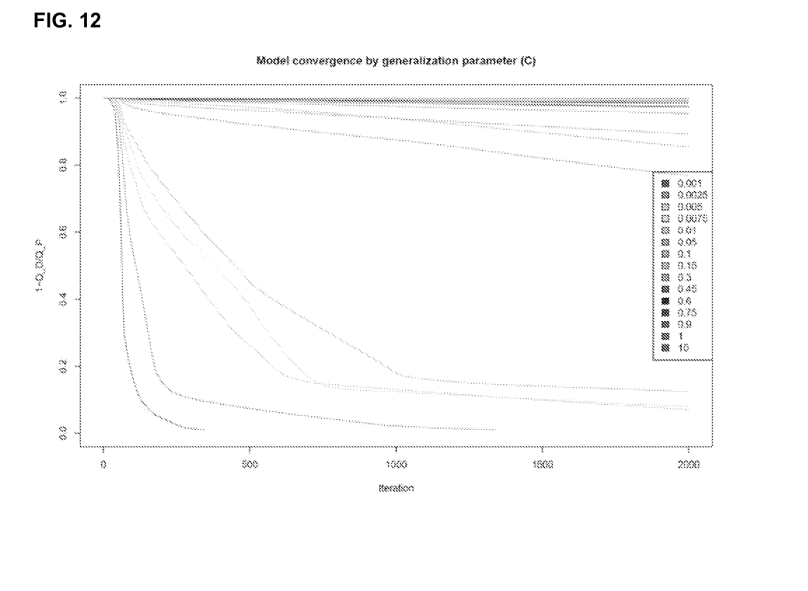

SVM models were trained, using various values for the generalization parameter (C), which assigns the cost of misclassifications. FIG. 12 shows the model training convergence in 2000 iterations (˜70 h) for different settings of C. These results indicate that model training only converges within a reasonable amount of time for C values around 0.0025 and below. Therefore models were trained for all ten training data sets with C=0.0025 and then compared predicted values for 100,000 random single nucleotide variants from 1000 Genomes and chromosome 21. The predicted values are highly correlated (all pairwise Spearman rank correlations >0.99; FIGS. 13A-13D). The average of the model parameters was determined, and the average model was used to continue.

F. Model Testing and Validation

All 8.6 billion possible substitutions in the human reference genome (GRCh37) were annotated, and the model was applied to score all possible substitutions. When scoring sites with multiple VEP annotation lines, all possible annotations were scored first and then the one with the highest deleteriousness after applying the four hierarchy levels was reported. As the scale of the model-based combined scores (“C-scores”) resulting from the SVM model is effectively arbitrary, the C-scores were mapped to a phred-like scale (“scaled C-scores”) ranging from 1 to 99 based on their rank relative to all possible substitutions in the human reference genome, i.e. −10log₁₀(rank/total number of substitutions). For example, the 1% (10⁻²) of all possible substitutions with the lowest scores—that is, least likely to be observed human alleles under the model—were assigned values of 20 or greater (“C20”). Several datasets extracted from the literature and public databases were used to look at the performance of the model scores.

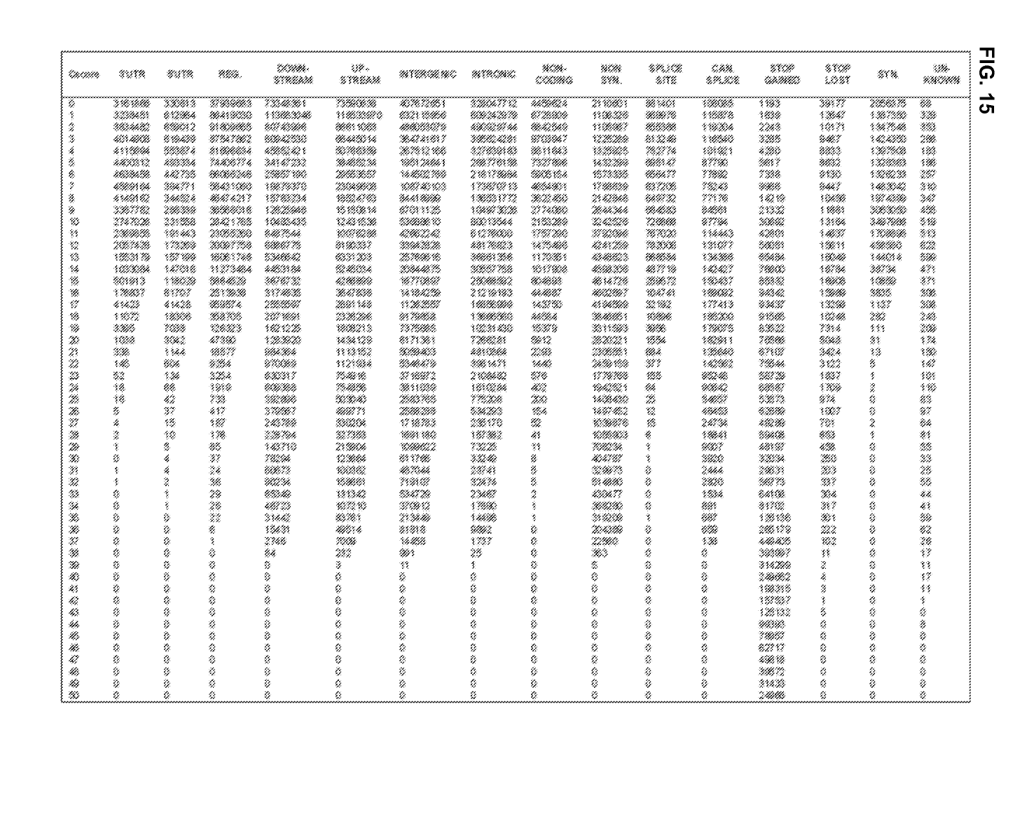

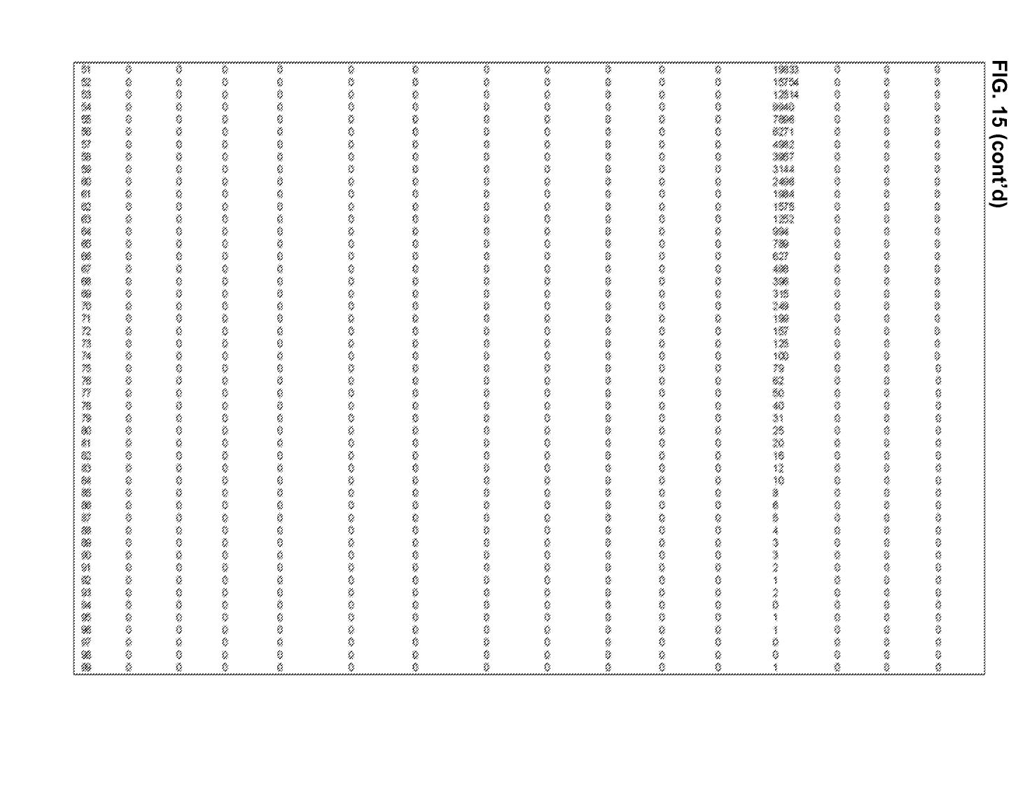

Functional consequences for possible substitutions to reference genome. In accordance with the model described above, the proportion of all possible substitutions with a given scaled C-score having specific functional consequences was calculated (FIG. 14 and FIG. 15). Although trained solely on differences between observed and simulated variants rather than on sets of known disease-causing variants that might introduce ascertainment bias, C-scores were highest for potential nonsense variants (median of 37) and were next highest for missense and canonical splice-site variants (median of 15), whereas intergenic variants comprised the variants with the lowest C-scores (median of 2). However, 76% of potential SNVs with C-score of 20 were noncoding (falling into categories other than missense, nonsense, canonical splice site or stop loss), whereas 74% of potential missense and 18% of potential nonsense SNVs had C-scores <20. Further, within each functional class, there were distinctions that are biologically relevant and are likely predictively useful. For example, potential nonsense variants—often treated as a homogeneous group in disease studies—in olfactory receptor genes had lower scores than variants in other genes, whereas potential nonsense variants in genes found previously to be essential (Liao & Zhang 2008) had higher scores (FIG. 14, bottom, and FIG. 16). C-scores thus capture a considerable amount of information, both in comparisons of functional categories and analysis within specific functional categories. Of note, these distinctions were absent or muted with other measures, either owing to missingness (for example, for missense-only measures) or lack of functional awareness (for example, conservation measures cannot distinguish between a nonsense and a missense allele at a given position).

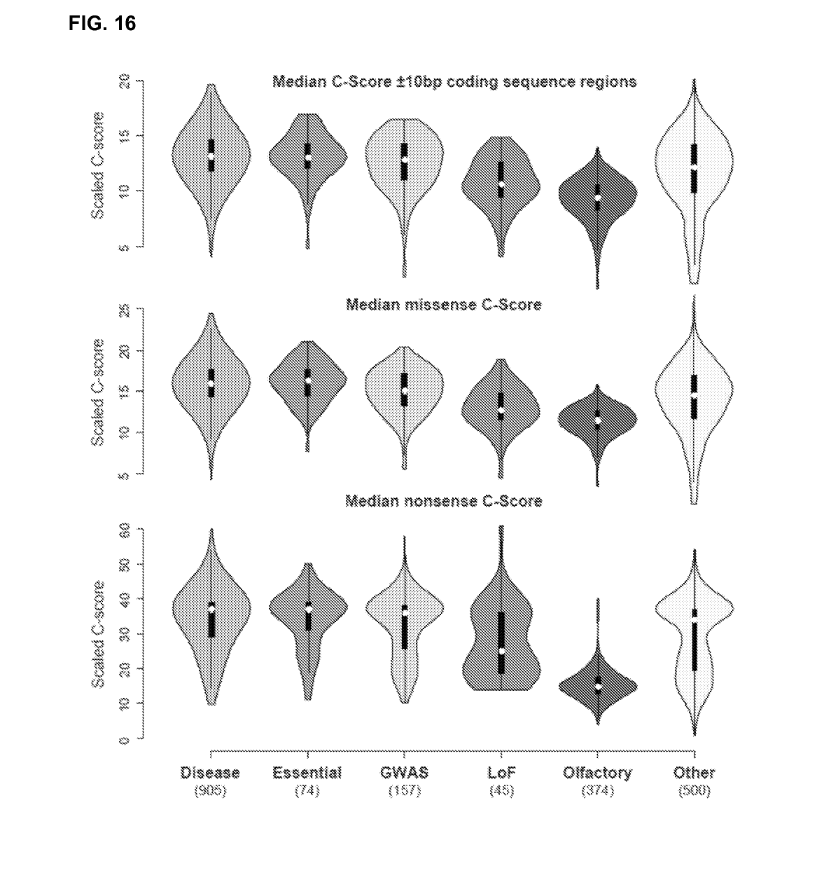

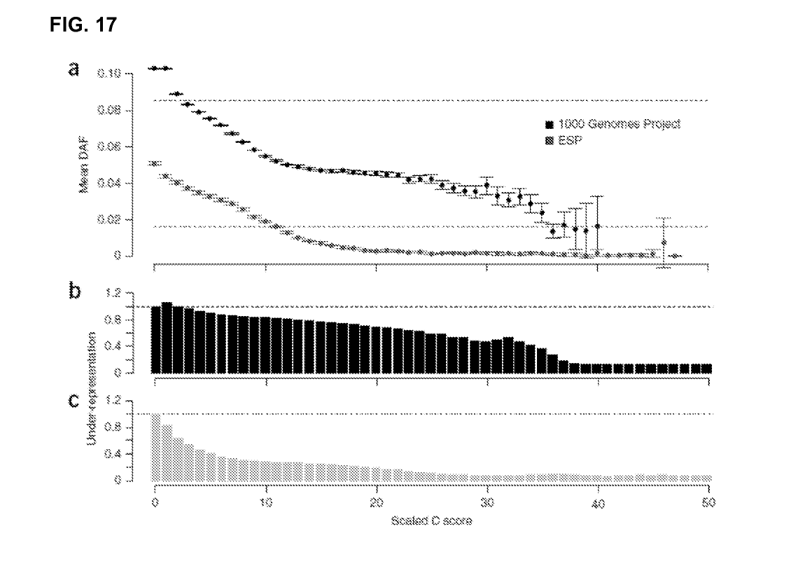

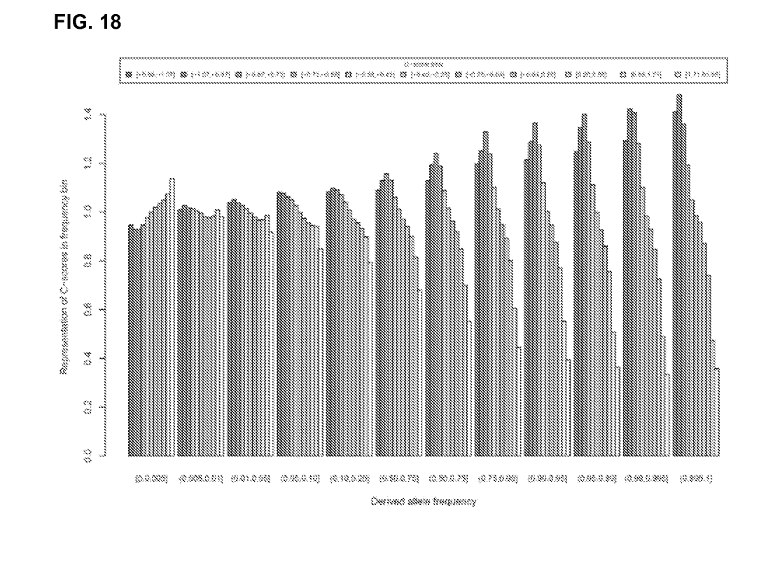

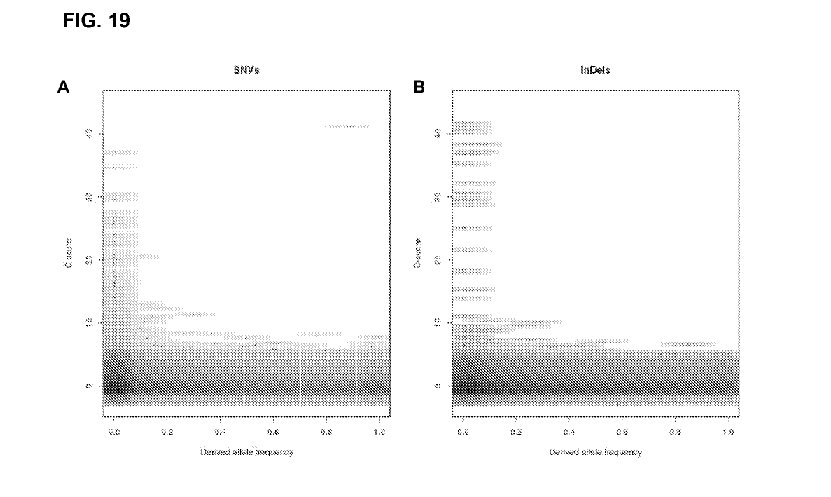

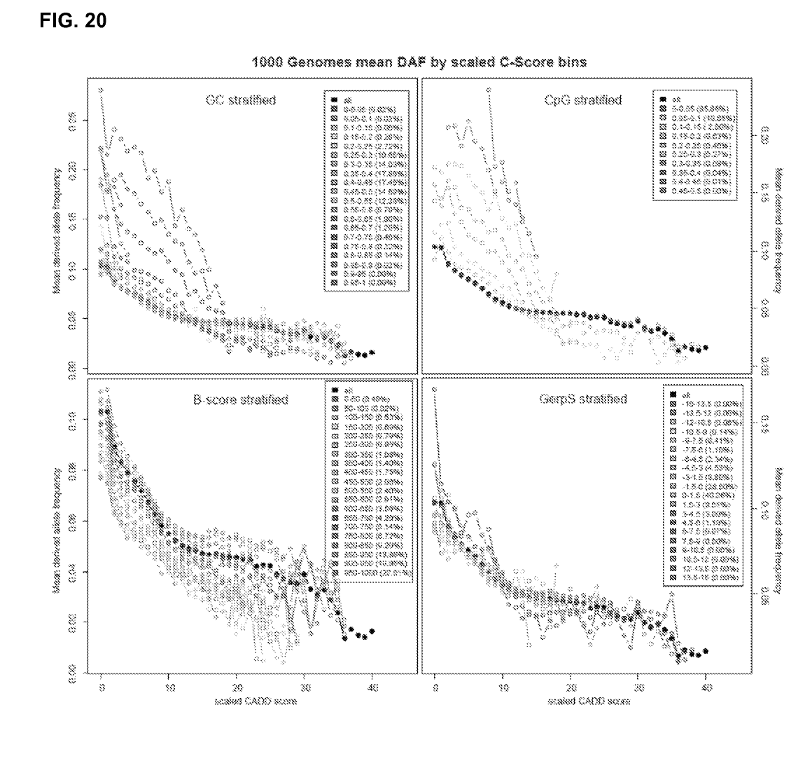

Genetic diversity for all possible substitutions to reference genome. Scaled C-scores were compared with levels of genetic diversity, finding that C-scores were negatively correlated with the average derived allele frequencies (DAFs) of variants listed by the 1000 Genomes Project (1000 Genomes Project Consortium et al. 2012) or the Exome Sequencing Project (Fu et al. 2013) (ESP) (FIG. 17a and FIGS. 18-20), depletion of human genetic variation from the 1000 Genomes Project catalog (FIG. 17b) and depletion of chimpanzee-derived variants (FIG. 17c). Notably, these validation data sets had minimal overlap with the observed subset for the training data, which consisted only of fixed or nearly fixed (DAF>95%) human-derived alleles. Furthermore, although confounding could not be fully eliminated by these factors, the negative correlation between C-scores and DAFs for standing variation was robust to controlling for variation in background selection, local GC content, local CpG density and site-based conservation (FIG. 20).

### Example 2

### Prioritizing Functional and Disease-Relevant Variants

The CADD framework described above may be used for prioritizing functional and disease-relevant variation. This use is evidenced in accordance with the five distinct contexts as described below. For these contexts, several data sets extracted from the literature and public databases and were used to examine the performance of model scores.

A. C-Scores in Specific Gene Classes.

To determine the relationship of C-scores within specific gene classes, the following groups of genes were obtained for analysis: (i) genes with at least 5 disease mutations (“DM”; missense, non-sense and indels) from HGMD (Stenson et al. 2009); (ii) 120 human non-immune essential genes (with associated diseases) described by Liao et al. (“essential”) (Liao et al. 2008); (iii) GWAS genes as available from the reported genes column of http://www.genome.gov/Pages/About/OD/OPG/GWAS%20Catalog/GWASCatalog112608.xls; (iv) loss-of-function (LoF) genes from MacArthur et al. (MacArthur et al. 2012; supplementary material 1, filtered column==0, at least 2 observations); and (v) olfactory genes by matching “olfactory receptor” in the description field of the Ensembl 68 gene build.

All obtained gene IDs were matched to Ensembl 68 protein-coding gene identifiers and following hierarchy for genes observed in multiple categories were applied: essential, disease, GWAS, olfactory, LoF. In addition, 500 random non-overlapping protein-coding genes were selected for the “other” category. FIG. 16 shows the median SNV C-scores across these genes coding sequence (padded by 10 bp around each exon), the median C-score for putative missense (non-synonymous) variants and the median C-score of putative non-sense (stop-gained) variants.

B. MLL2 Variants.

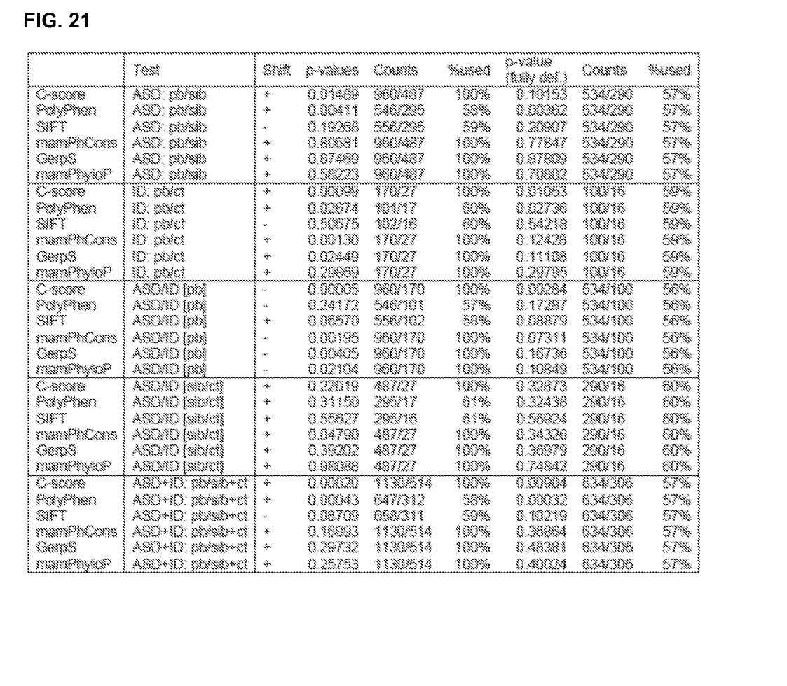

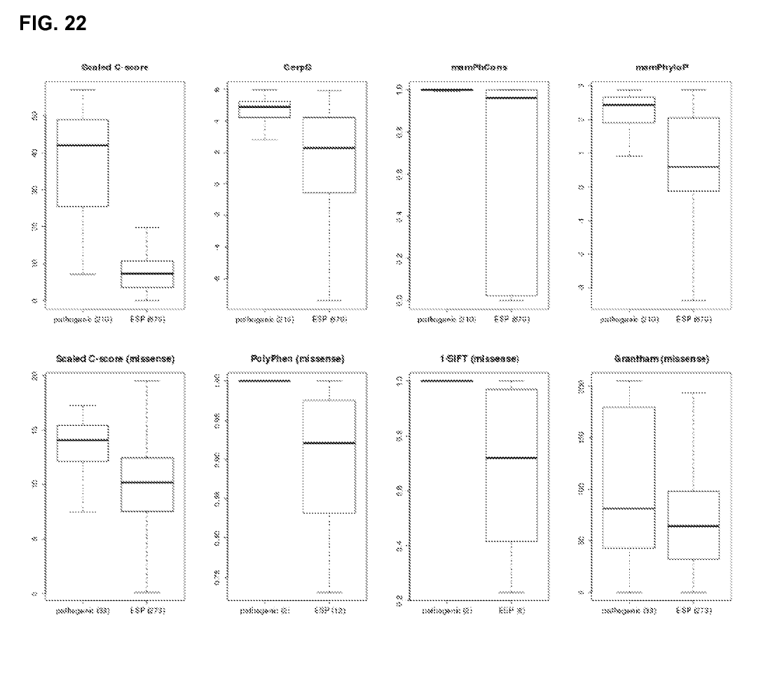

A total of 210 mutations in KMT2D (MLL2) associated with Kabuki syndrome were downloaded (see mutations in Makrythanasis et al. 2013, which is hereby incorporated by reference as is fully set forth herein). From the variants in FIG. 21 of Makrythanasis et al. 2013, variants marked as possibly non-pathogenic and variants annotated on NG_027827.1 were excluded, as these could not automatically be converted to genomic coordinates using VEP (McLaren et al. 2010). The variants were complemented with 679 putatively benign variants observed in the Exome Sequencing Project (ESP) (Tennessen et al. 2012), 273 of which are non-synonymous. Results for this data set are presented in FIG. 22.

The Kabuki syndrome-associated KMT2D (MLL2) variants are 46% frameshift indels, 37% nonsense, 16% missense, 1% inframe indels and <1% splice site events, while the ESP-based MLL2 variants are 40% missense, 31% synonymous, 21% intronic, 3% splice site events, 2% inframe indels and 6% other. Further, C-scores for the KMT2D (MLL2) variants enabled the discrimination of a diverse set of disease-associated alleles (Makrythanasis et al. 2013) from rare, likely benign variants listed in ESP (Fu et al. 2013) (Wilcoxon rank-sum test P=9.9×10⁻⁹⁴; n=210 disease associated/679 likely benign). Other metrics were markedly inferior in terms of accuracy or comprehensiveness (FIG. 22).

C. HBB Variants.

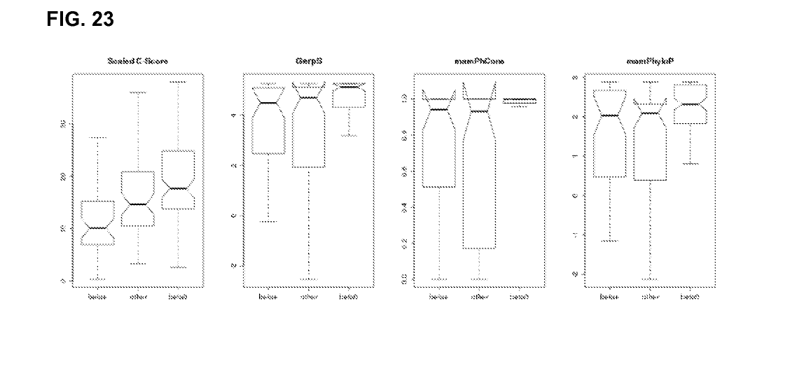

A total of 119 SNVs, 30 insertions and 63 deletions (all required to be at most 50nt) within or near HBB that give rise to β-thalassemia from HbVar (Giardine et al. 2007) were downloaded. Disease categories were used as defined by HbVar, except that all types that are not “beta0” or “beta+” were pooled into one category, “other”. Results for this analysis are presented in FIG. 23. These variants are 13% frameshift indels, 11% missense, 8% nonsense, 17% splice site events, 20% deletions of unknown effect, 25% upstream/regulatory, and 4% other.

C-scores of disease-associated alleles (Giardine et al. 2007)—a set of indels (n=93) and SNVs (n=119) with regulatory/upstream (n=54), splicing (n=37), missense (n=22), nonsense (n=18) and other effects—were significantly and more strongly correlated with 3 levels of phenotypic severity than other measures (Kruskal-Wallis rank-sum test P=2.4×10⁻⁷; n=48 mild/65 intermediate/99 severe; FIG. 23).

D. ClinVar.

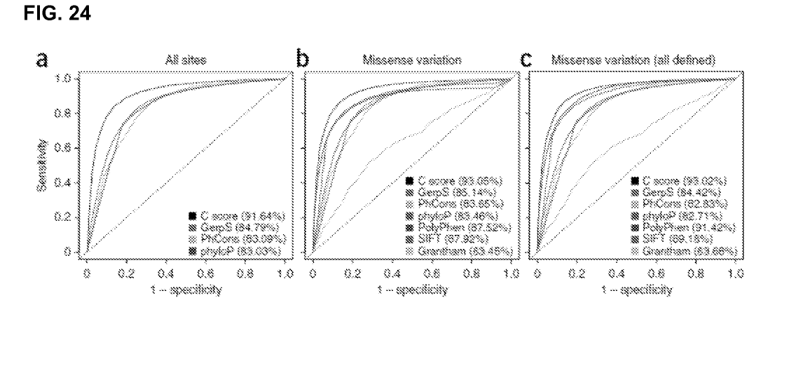

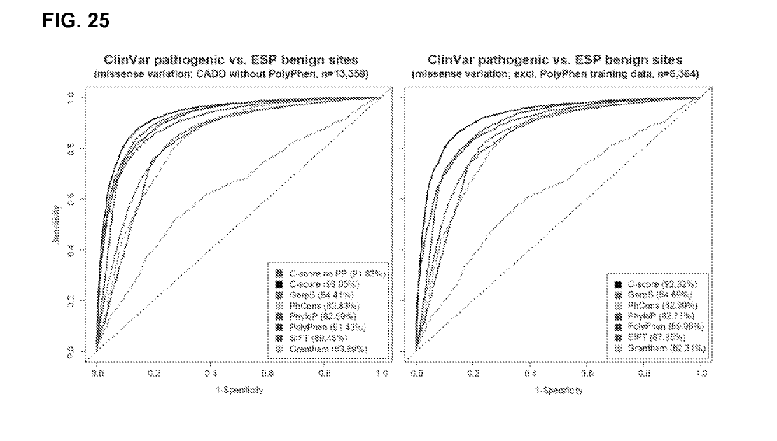

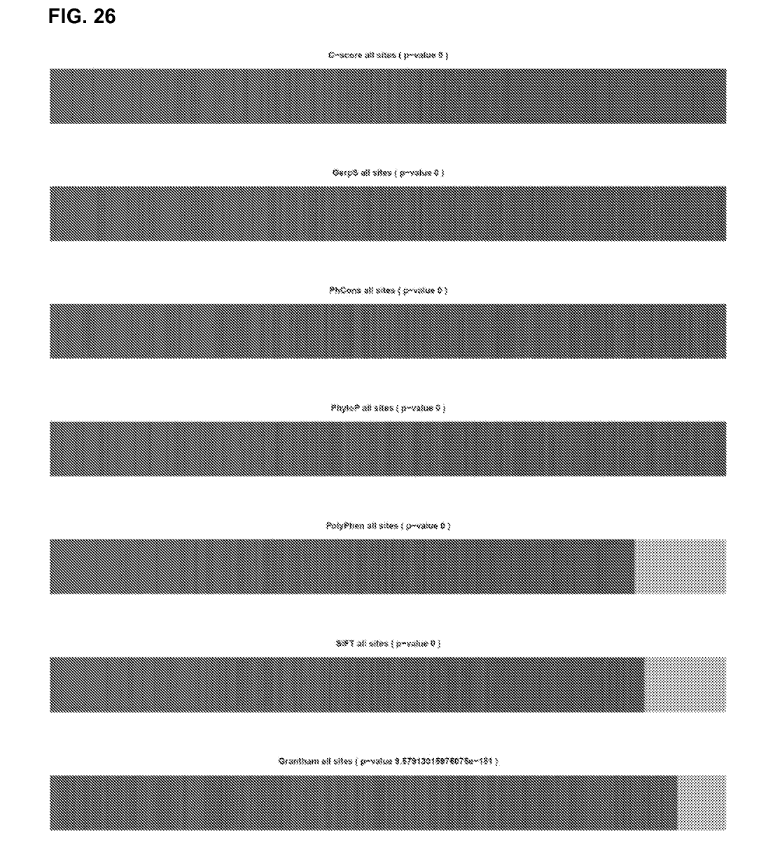

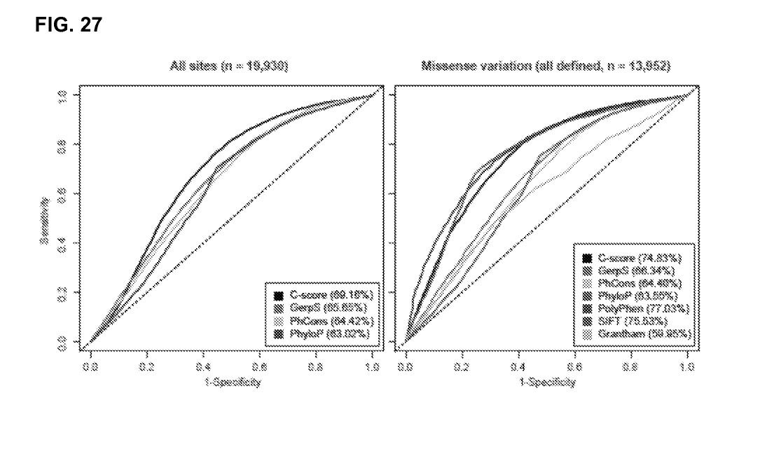

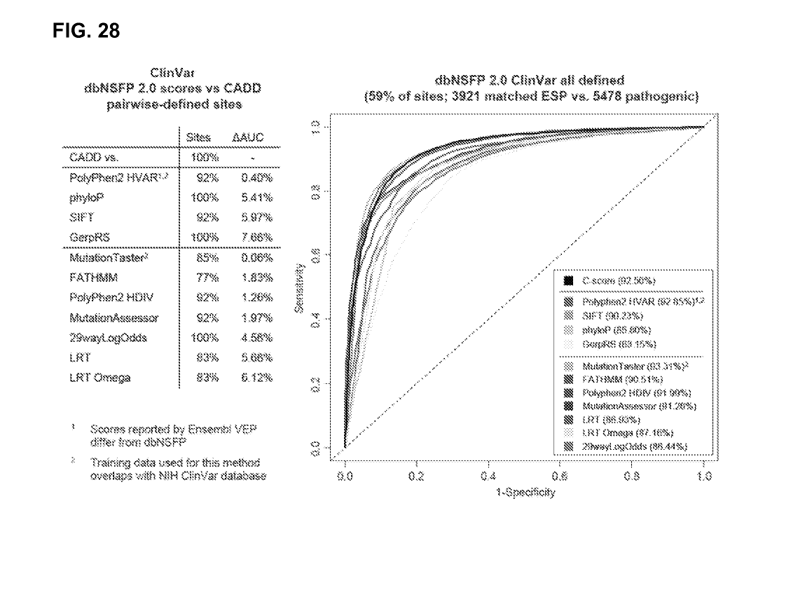

The ClinVar (Baker 2012) data set (release date Jun. 16, 2012, ftp://ftp.ncbi.nih.gov/snp/organisms/human_9606/VCF/clinvar_00-latestvcf.gz) was obtained from the American National Center for Biotechnology Information (NCBI). Variants that were marked “pathogenic” or “non-pathogenic (benign)” were extracted. However, it was noticed that the benign variation had a very different composition in terms of the Consequence annotation compared to the pathogenic variation. Due to the restriction of the most predictive publically available scores (i.e. PolyPhen, SIFT) to non-synonymous changes, those scores were underrepresented in the benign set. Therefore a set of apparently benign (≧5% allele frequency) variants were selected from ESP that were matched to the pathogenic ClinVar sites in terms of their Consequence annotations. In addition, a data set was generated where ESP and ClinVar frequencies were matched to three decimal precisions of the alternative allele frequency. Further, due to the overlap of ClinVar and ESP variants with the PolyPhen training data set, a separate classifier was trained without the PolyPhen features and the performance on the subset of ClinVar and ESP variants not used for PolyPhen training was also checked. To compare the performance of CADD with other publically available missense annotations not used in model training, scores from dbNSFP 2.0 (Liu et al. 2011) were downloaded. Finally, ClinVar pathogenic variants were analyzed in the context of the eleven men data (see Example 3 below). Results for these analyses are presented in FIG. 24 as well as FIGS. 25-29. Briefly, pathogenic variants curated by the US National Institutes of Health (NIH) ClinVar database (Baker 2012) were well separated from likely benign alleles (ESP (Fu et al. 2013) DAF≧5%) matched to the same categorical consequences (Wilcoxon rank-sum test P<1×10⁻³⁰⁰, n=8,174 pathogenic/8,174 likely benign.

The ClinVar pathogenic variants used here are 76% missense, 18% nonsense, 3% splice site events, 1% frameshift indels and 2% other (and ESP benign variants were always matched to the same distribution of categorical consequences). It is noted that there was substantial overlap between ClinVar and the training data underlying PolyPhen. When the corresponding sites were excluded from the test data set or when PolyPhen was excluded as a training feature from CADD, C-scores continued to outperform all or nearly all missense-only metrics and conservation measures (FIG. 25).

E. ALDOB, ECR11 Enhancers and HBB Promoter.

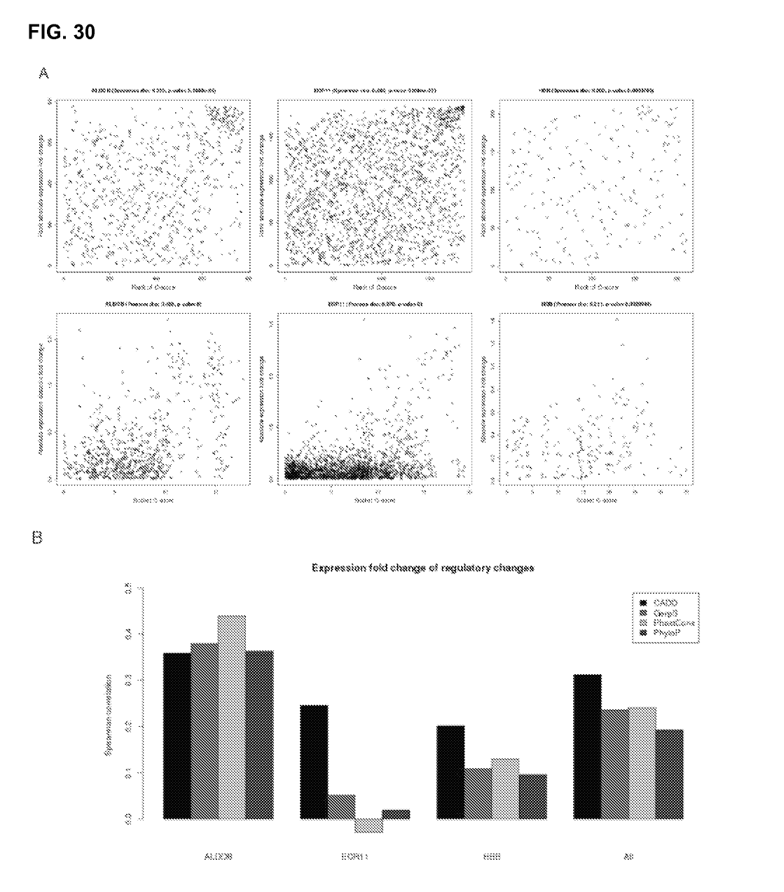

The expression fold change was obtained for each base substitution in ALDOB and ECR11 enhancers from a data set which contains a total of 777 variants for ALDOB and 1860 variants for ECR11 (see Patwardhan et al. 2012. Supplementary data, http://www.nature.com/nbt/journal/v30/n3/extref/nbt.2136-S2.zip, the subject matter of which is incorporated by reference as if fully set forth herein). Further, HBB promoter data was obtained from a data set which contains a total of 210 variants associated with an expression fold change (see Patwardhan et al. 2009, Supplementary data, http://www.nature.com/nbt/journal/v27/n12/extref/nbt.1589-S2.zip, the subject matter of which is incorporated by reference as if fully set forth herein). Results for this analysis are presented in FIGS. 30A-B.

The two enhancers (Patwardhan et al. 2012) and one promoter (Patwardhan et al. 2009) were examined, in which saturation mutagenesis was previously performed. C-scores were significantly correlated with experimentally measured fold change in absolute expression from individual variants and were overall more significantly correlated than measures of sequence conservation (Spearman rank correlation of combined data=0.31, P=1.9×10⁻⁶⁵, n=2,847; FIGS. 30A-B).

F. IARC p53 Variants.

A list of 23,788 single nucleotide somatic cancer mutations in p53 were obtained, which were reported to the International Agency for Research on Cancer (IARC, http://p53.iarc.fr/TP53Somatic Mutations.aspx). These mutations correspond to 2,068 distinct variants. The number of times that each variant was reported was recorded. The Spearman rank correlation between the number of observations per variant and the C-score is 0.38, p=5.8×10⁻⁷³ (n=2,068). Accordingly, the C-scores strongly correlated with the number of observed somatic cancer mutations in TP53 (encoding p53) reported to the International Agency for Research on Cancer (IARC)

G. Summary.

Collectively, these analyses demonstrate that CADD is quantitatively predictive of deleteriousness, pathogenicity and molecular functionality, both protein altering and regulatory, in a variety of experimental and disease contexts. In each of these contexts, the predictive usefulness of CADD was much better than measures of sequence conservation, the only comprehensive type of variant score, and also tended to be better, in most cases substantially so, than function-specific metrics when restricted to the appropriate variant subsets.

### Example 3

### Application of CADD to Human Genetics

The CADD framework described above is also useful in evaluating candidate variation within exome or genome-wide studies, as evidenced by the following studies.

A. Autism and Intellectual Disability Variants.

All high confidence de novo mutations were combined from five family based autism exome sequencing studies (O'Roak et al. 2011; O'Roak et al. 2012; Sanders et al. 2012; Neale et al. 2012; lossifov et al. 2012). Calls from individuals studied in multiple studies were merged for a total of 948 ASD probands and 590 unaffected siblings. These included all validated variants from studies (O'Roak et al. 2011; O'Roak et al. 2012; Sanders et al. 2012; Neale et al. 2012; lossifov et al. 2012) as well as all sites from lossifov et al. (lossifov et al. 2012) that passed SNVFilter and IndelFilter. Only coding and canonical splice-site positions were considered. Coding sites were defined by RefSeq, CCDS, and UCSC genes. All indel start positions (noting the position prior to the change) and alleles were reformatted to match the current VCF convention. In the case of complex mutation events (i.e. multiple base changes in close proximity) where multiple nucleotide changes were predicted to alter the protein, the complex mutation was provided to VEP, treating it like an indel for the scoring process. For sites with a non-synonymous and synonymous change, only the non-synonymous was considered. For the special case of two missense events reported in 12624.p1 (separated by 1.9kb, involving a possible processed pseudogene), only the 5′-most variant (12:58129165) was considered.

Further, the coding variants were obtained as described above for two family-based intellectual disability (ID) studies (Rauch et al. 2012; de Ligt et al. 2012). These calls came from 151 ID and 20 unrelated control families.

The de novo exome variants (SNVs and indels) identified in children with autism spectrum disorders (ASD) and intellectual disability (see above) were analyzed along with unaffected siblings or controls, considering 88 nonsense, 1,015 missense, 359 synonymous, 32 canonical splice-site and 150 other variants, including indels. This correlates to 61%/63% missense variants, 6%14% nonsense variants, 4%/2% splice site events, 20%/25% synonymous variants, and 10%/6% other variants in probands and controls for ASD and intellectual disability, respectively.

Results of this analysis are shown in FIG. 21. Briefly, variants in affected children were significantly more deleterious than variants in unaffected siblings or controls when each disorder was considered separately (FIG. 21) or in combination (ASD+intellectual disability Wilcoxon rank-sum test P=2.0×10⁻⁴, n=1,130 probands/514 controls). Additionally, de novo variants in probands with intellectual disability were significantly more deleterious than variants in probands with ASD (P=4.7×10⁻⁵, n=170 intellectual disability/960 ASD), suggesting a more deleterious global mutation burden in intellectual disability, which is consistent with the observation of increased sizes and numbers of copy number variants in intellectual disability relative to ASD (Cooper et al. 2011b).

B. Eleven Men.

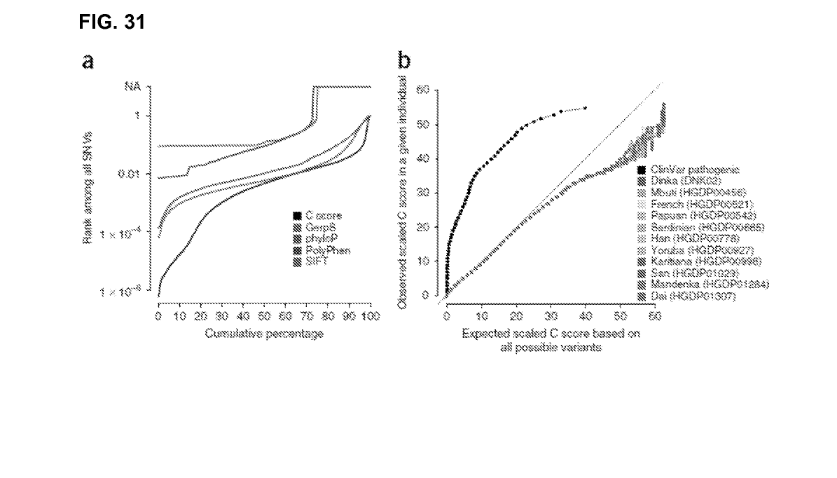

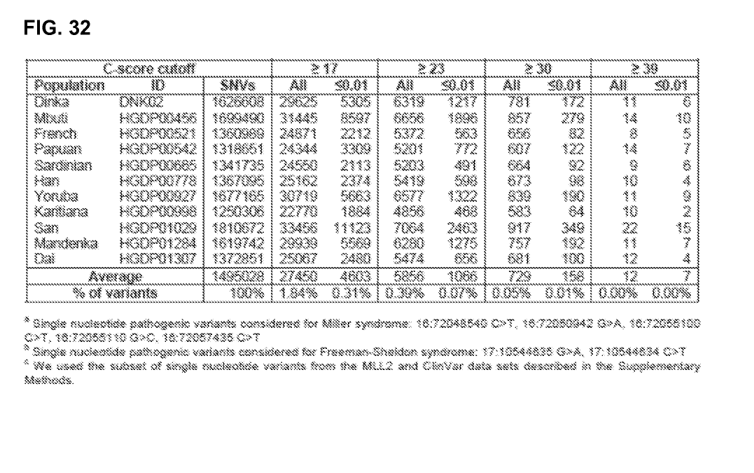

GATK VCF variant call files were obtained for all autosomes and the X chromosome from shotgun sequencing of eleven men originating from diverse human populations (Meyer et al. 2012, see http://cdna.eva.mpg.de/denisova/VCF/human/). Variants were filtered as previously described (Meyer et al. 2012) using the annotation available in the obtained VCF files. The following variant positions were removed: (1) positions with extremely high or low coverage (upper and lower 2.5% of the coverage distribution for each sample), (2) positions surrounding insertions/deletions (±5 by of an insertion/deletion), (3) positions identified as prone to systematic error in Illumina sequencing, (4) positions marked by soft masking in the human reference sequence, (5) positions with a 20-mer mapability score <1, (6) positions with genotype quality (GQ) <40, as well as (7) positions with a non-empty GATK flag field. Results of this analysis are shown in FIG. 31 and the tables shown in FIGS. 32 & 33.

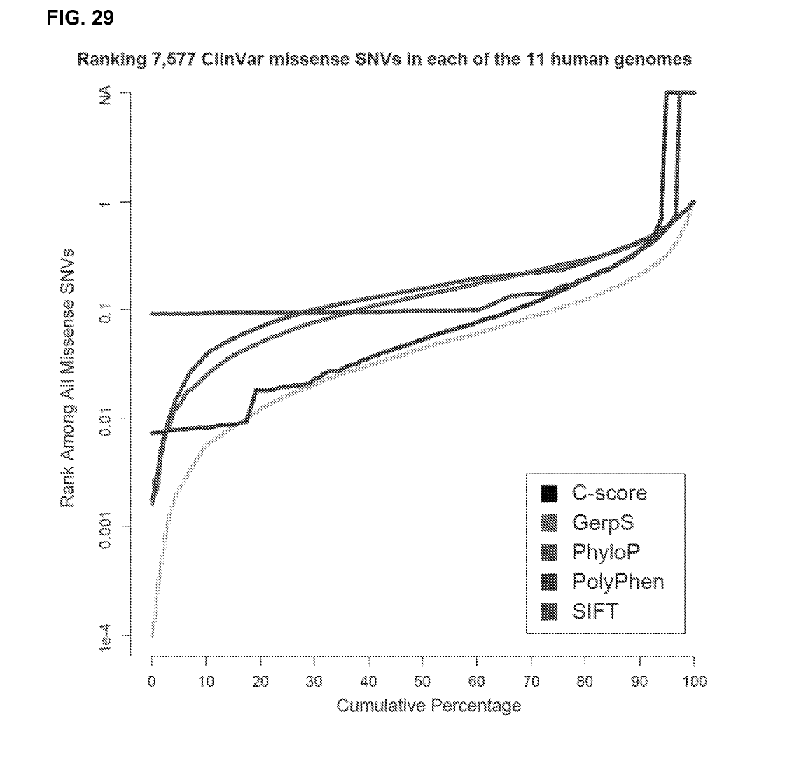

It is well established that annotations such as PolyPhen and conservation scores are valuable in the sequencing-based identification of disease-causal genes by virtue of their ability to highly rank pathogenic variants (Cooper et al. 2010; Cooper & Shendure 2011a; Ng et al. 2010). Therefore, the distribution of C-scores for variants in the genomes of 11 individuals representing diverse populations (Rohland & Reich 2012) were examined, finding that CADD highly ranked known disease-causal (ClinVar pathogenic) variants within the complete spectrum of variation in personal genomes (FIG. 31, FIG. 29, and the tables shown in FIGS. 32 & 33). Furthermore, CADD was both more quantitative and more comprehensive in this task (for example, ˜27% of pathogenic ClinVar SNVs were not scored by PolyPhen because of missing values or the restriction of PolyPhen to missense variation). Given its considerable superiority over the best available protein-based and conservation metrics in terms of ranking known pathogenic variants in the complete spectrum of variation within personal genomes, CADD will likely improve the power of sequence-based disease studies beyond that achieved with current standard approaches.

C. Increased C-Scores of GWAS Lead SNPs.

The National Human Genome Research Institute (NHGRI) genome-wide association study (GWAS) catalog was downloaded (http://www.genome.gov/gwastudies/), which included 9,977 distinct SNP-trait associations spanning 7,531 unique SNPs in the 1000 Genomes release (v3 20101123); these variants are hereafter referred to as “lead SNPs”. The Genome Variation Server (GVS, http://gvs.gs.washington.edu/GVS137/) was used to find all SNPs within 100 kb of a lead SNP that have a pairwise correlation of R²>=0.8 within Utah residents with ancestry from northern and western Europe (CEU); it is noted that not all GWAS studies in the catalog were conducted within populations of European ancestry, but CEU was chosen as the single most broadly applicable population. This resulted in an additional 56,538 unique SNPs, hereafter referred to as “tag SNPs”. Lead and tag SNPs are referred to as “trait-associated” or simply “associated”.

“Control” SNP sets were also developed, and were selected to match trait-associated SNPs for a variety of features that may bias SNPs found by GWAS in the absence of any causal effects. Specifically, for each trait-associated SNP the closest SNP that has the same reference and alternate alleles, has a 1000 Genomes average alternate allele frequency within 5%, and has a similar SNP array presence profile was chosen. For the last criterion, rather than attempt to match for all possible SNP array designs, a match for presence/absence on four widely used genotyping arrays that were directly used in many GWASs and indirectly capture many of the general biases that affect SNP array design was chosen: Affymetrix 5.0, Affymetrix 6.0, Illumina HumanHap 550, and Illumina 1M. Each control SNP was required to match the exact same combination of array presence/absence; for example, if an associated SNP is present on both Affymetrix arrays but neither Illumina array, then its matched control must also be present on both Affymetrix arrays and neither Illumina array.

No control SNPs were selected more than 500 kbp away from an associated SNP, and each control SNP was assigned to one and only one associated SNP. In total, 5,498 lead SNPs (˜73%) and 46,195 tag SNPs (˜82%) were matched. The median distance between associated SNPs and their matched controls is 32,601 bp, while the median alternate allele frequency difference between associated SNPs and matched controls is 2%.

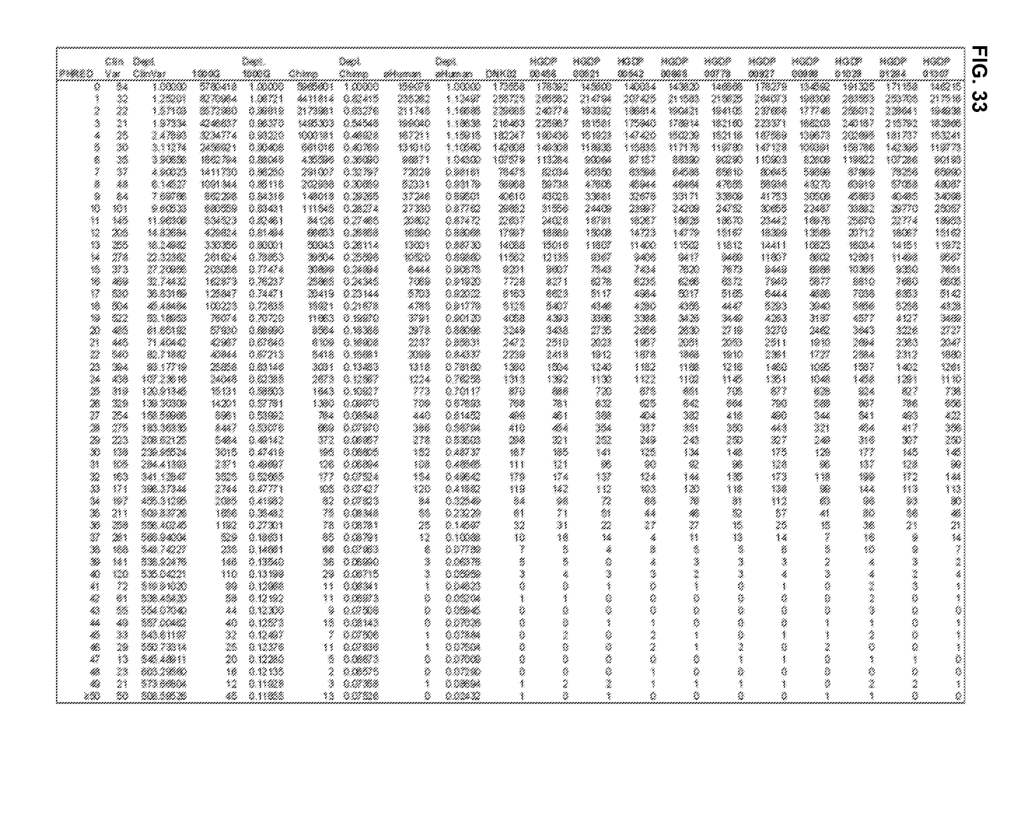

C-score distributions were subsequently compared between the associated and control SNPs defined above. Details of all statistical tests, including SNP set descriptions, counts, and p-values, are supplied in FIG. 33. It is noted that, while scaled CADD score means are presented in the FIGS. and Tables to ease interpretation, most p-values below are computed using a Wilcoxon one-sided test on unscaled C-scores (similarly significant p-values and trends emerge using scaled or unscaled C-scores and using parametric or non-parametric tests, not shown).

It was found that lead GWAS SNPs had significantly higher C-scores than control SNPs (one-sided Wilcoxon rank-sum test P=1.3×10⁻¹², n=5,498 GWAS/5,498 control); nearby SNPs in linkage disequilibrium with lead SNPs (tag SNPs) scored lower on average than lead SNPs but also had significantly higher scores than their matched controls (P=5.1×10⁻¹⁰⁷). Lead SNP C-scores are significantly higher than lead-matched controls (p=1.27×10⁻¹²); the difference is less pronounced, in terms of absolute score difference, for tag SNPs but also highly significant (p=5.11×10⁻¹⁰⁷). The drop in scores from lead (mean scaled C-score of 4.46) to tag SNPs (mean of 3.89) would be expected if causal variants are more highly enriched among lead SNPs relative to tag SNPs, as is likely given that lead SNPs for any given locus are selected on the basis of showing the strongest association signal within that locus (www.genome.gov/gwastudies). However, the differences between leads and tags also correlates with differences in allele frequencies, as tag SNPs tend to have higher alternate allele frequencies (median of 35%) than lead SNPs (median of 32%) and would thus tend to exhibit lower CADD scores as a result (FIG. 14).

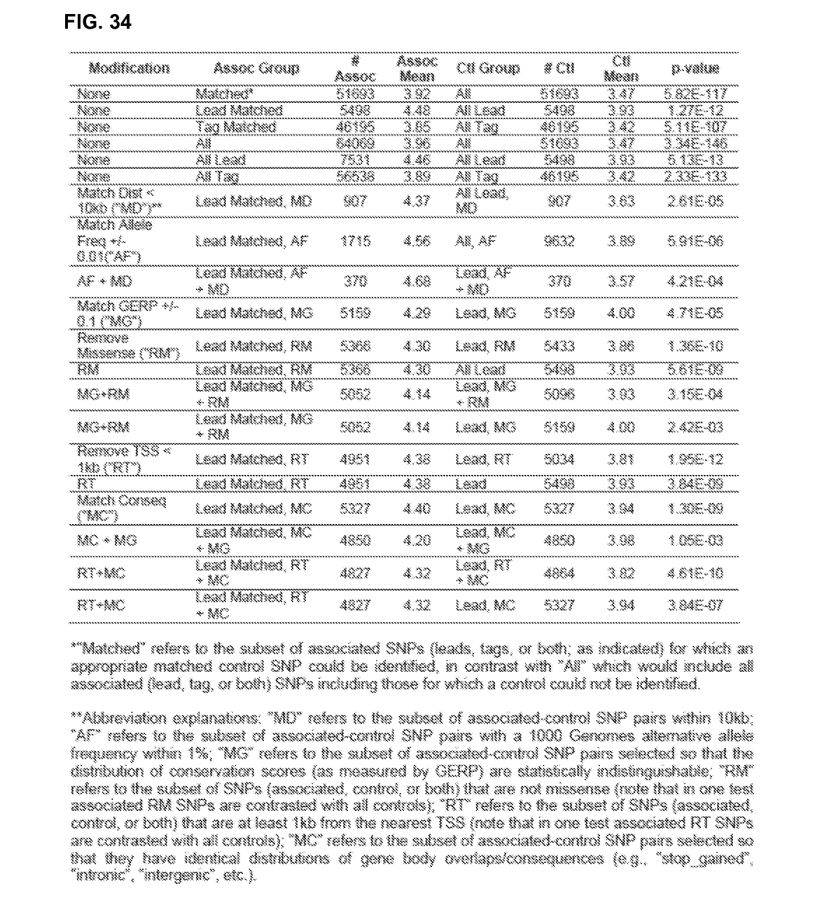

Differences in C-score remained significant after controlling for properties such as gene-body effect, gene expression level, conservation and regulatory element overlap; each of these properties was significantly different (all P<0.01) for associated and control SNPs, but none could fully explain discrepancies in C-score (FIG. 34).

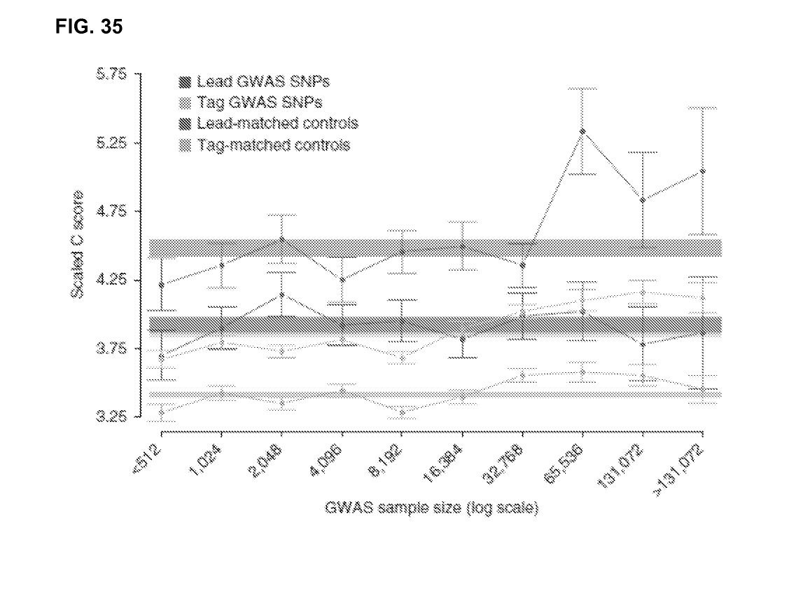

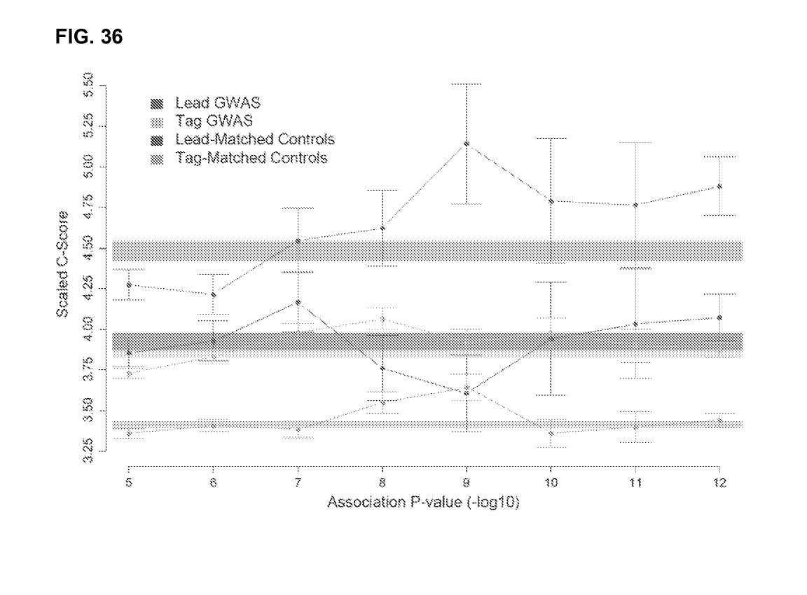

Further, CADD scores for SNPs identified by GWAS of complex traits were analyzed, contrasting them with scores for nearby control SNPs matched for allele frequency and genotyping array availability (FIG. 35). C-scores for trait-associated SNPs correlated with the sample size of the underlying association study that identified the associated SNP, as well as with the statistical significance of the association itself (FIG. 35, FIG. 36). In particular, it was found that C-scores correlate with the sample size of the study that identified the associated SNP (FIG. 35; Kendall's rank correlation tau=0.020; one-sided test p=2.38×10⁻¹²; note that SNPs found by multiple studies were assigned the largest sample size of the relevant studies). Matched control C-scores also correlate significantly, but less strongly than associated SNPs, with sample size (tau=0.012; p=3.32×10⁻⁵). This is likely due to the increased ability of larger studies and stronger association statistics to enrich for causal variants, therefore suggesting that changes in array-biases over time, differential regional enrichment effects of large vs. small studies, the more frequent usage of imputation methods in more recent (often larger) studies, or other technical confounders may contribute to the sample-size dependency observed for associated SNPs. However, the sample-size effect is substantially more pronounced in associated relative to control SNPs (FIG. 35, also compare correlation coefficients and significance estimates), and the difference between associated and control SNP C-score distributions widens as sample size increases. For example, from studies with sample sizes above the median (4,234 samples), the mean lead SNP scaled C-score is 4.63 vs a lead-matched control mean of 3.89 (difference of 0.74); for studies with sample sizes at or below the median, the lead SNP scaled C-score mean is 4.34 relative to a lead-matched control of 3.96 (difference of 0.38).

Very similar results are observed when comparing C-scores to the p-values of the individual associations (FIG. 29). Although for the most part not causal, GWAS-identified SNPs, especially strongly associated lead SNPs from large studies, were found by the present analysis to be enriched for causal variants, consistent with previously observed GWAS enrichments for individual annotations (ENCODE Project Consortium et al. 2012; Hindorff et al. 2009; Nicolae et al. 2010; Gerstein et al. 2012; Schaub et al. 2012), and assuming that stronger associations are more heavily enriched for causal variants (it is noted that study sample size and association p-value are highly correlated to one another, as smaller p-values tend to derive from larger studies).

The above results were generated using only those associated SNPs for which a match could be obtained; associated SNPs for which no match could be identified (i.e., no SNP meeting all the matching criteria within 500 kbp) have similar C-scores as associated SNPs with a match and also correlate with sample size and association significance (not shown). Their inclusion therefore tends to result in similarly highly significant test results as those presented here.

In addition, it was found that neither physical distance nor allele frequency discrepancies can explain the effects that were observed. For example, CADD scores are significantly higher for lead SNPs that are <10 kb from their matched control, for those that have a similar (+/−1%) 1000 Genomes alternate allele frequency as their matched control, and also for lead SNPs that meet both criteria (FIG. 33).

Moreover, the role of individual annotation contributions to the C-score differences between associated and control SNPs was examined. In particular, the contributions of missense variation, distance to transcriptional start site (TSS), gene body overlap/consequence, and sequence conservation were evaluated. Such annotations may have intrinsic biases with respect to GWAS signals but are also likely to correlate with variant functionality/causality. Indeed, these features are among the most widely used criteria to evaluate candidate variants in disease studies and among the largest individual contributors to C-scores (FIG. 3).

It was found that each annotation explains part of the C-score differences, but none are sufficient to fully explain them, even when conservatively controlled for alone or in combination. For example (all relevant p-values and other information can be found in FIG. 33):
Lead SNPs are enriched for missense effects relative to controls (2.5% vs 1.2%), but the C-score difference remains significant after excluding missense variants from both lead and lead-matched controls, and remains significant even if missense variants are purged from lead SNPs but allowed to remain in controls.
If lead SNPs are matched with controls such that they have identical distributions of gene body overlaps/consequences (e.g., “intronic”, “5prime_utr”, “non_synonymous”, etc.) annotations, it is found that CADD scores of associated SNPs are still significantly higher than controls.
Lead SNPs occur at significantly more conserved genomic positions, as measured by GERP (Cooper et al. 2005), than lead-matched controls (p=1.1×10⁻⁴). However, if lead SNPs are matched to controls on their GERP score (+/−0.1), essentially purging the excess of highly conserved lead SNPs such that lead SNPs are not significantly more conserved than controls (p=0.39), it is found that the difference in C-scores remains significant.
A variety of other individual functional annotations are mildly enriched among GWAS SNPs (p-values comparing CADD score distributions with and without exclusion of the many possible individual functional annotations are not provided), but none are particularly strongly predictive in either a discrete or quantitative sense. For example, from ENCODE cell line data, lead SNPs tend to more frequently overlap, relative to controls, more highly expressed genes (Wilcoxon one-sided p=0.0087), open chromatin marks (19% vs. 17%), transcription factor binding sites (20% vs 17%), and consensus binding motifs (11.3% vs 10.4%). None of these distinctions can individually explain, or are as statistically strong as, the full CADD score separation between associated and control SNPs.
If missense SNPs are eliminated and matched for conservation simultaneously, there remains a significant difference in C-scores between lead SNPs and controls, even if missense SNPs are removed from associated SNPs but retained in controls.

All the same trends and significant differences described here for lead and lead-matched control SNPs (i.e., controlling for conservation, gene consequence, missense, or distance to TSS) also hold for tag and tag-matched SNPs, with smaller absolute differences in C-scores that are more highly significant owing to the substantially increased SNP counts (not shown).

Thus, while clear single-annotation contributors to the GWAS SNP C-score increase can be found, no individual annotation differences are as statistically strong as that seen for C-scores and none can fully explain the observations described above. These observations suggest that CADD is able to effectively exploit multiple information sources and prioritize causal variants across a diverse range of functional and evolutionary categories.

### REFERENCES

The references, patents and published patent applications listed below, and all references cited in the specification above are hereby incorporated by reference in their entirety, as if fully set forth herein.
1000 Genomes Project Consortium et al. An integrated map of genetic variation from 1,092 human genomes. Nature 491, 56-65 (2012).
Adzhubei, I. A. et al. A method and server for predicting damaging missense mutations. Nat Methods 7, 248-9 (2010).
Arbiza, L. et al. Genome-wide inference of natural selection on human transcription factor binding sites. Nat. Genet. 45, 723-729 (2013).
Baker, M. One-stop shop for disease genes. Nature 491, 171 (2012).
Boyle, A. P. et al. High-resolution mapping and characterization of open chromatin across the genome. Cell 132, 311-322 (2008).
Chambers, J. M., Cleveland, W. S., Kleiner, B. & Tukey, P. A. Graphical Methods for Data Analysis, (Wadsworth International Group, Belmont, Calif., 1983).
Cooper, G. M. & Shendure, J. Needles in stacks of needles: finding disease-causal variants in a wealth of genomic data. Nat. Rev. Genet. 12, 628-640 (2011 a).
Cooper, G. M. et al. A copy number variation morbidity map of developmental delay. Nat. Genet. 43, 838-846 (2011 b).
Cooper, G. M. et al. Distribution and intensity of constraint in mammalian genomic sequence. Genome Res. 15, 901-913 (2005).
Cooper, G. M. et al. Single-nucleotide evolutionary constraint scores highlight disease-causing mutations. Nat. Methods 7, 250-251 (2010).
Davydov, E. V. et al. Identifying a high fraction of the human genome to be under selective constraint using GERP++. PLoS Comput Biol 6, e1001025 (2010).
de Ligt, J. et al. Diagnostic exome sequencing in persons with severe intellectual disability. N. Engl. J. Med. 367, 1921-1929 (2012).
ENCODE Project Consortium et al. An integrated encyclopedia of DNA elements in the human genome. Nature 489, 57-74 (2012).
Ewing, B. & Green, P. Base-calling of automated sequencer traces using phred. II. Error probabilities. Genome Res. 8, 186-194 (1998).
Franc, V. & Sonnenburg, S. Optimized cutting plane algorithm for large-scale risk minimization. J. Mach. Learn. Res. 10, 2157-2192 (2009).
Fu, W. et al. Analysis of 6,515 exomes reveals the recent origin of most human protein-coding variants. Nature 493, 216-220 (2013).
Fujita, P. A. et al. The UCSC Genome Browser database: update 2011. Nucleic Acids Res 39, D876-82 (2011).
Gerstein, M. B. et al. Architecture of the human regulatory network derived from ENCODE data. Nature 489, 91-100 (2012).
Giardine, B. et al. HbVar database of human hemoglobin variants and thalassemia mutations: 2007 update. Hum. Mutat. 28, 206 (2007).
González-Pérez, A. & Lopez-Bigas, N. Improving the assessment of the outcome of nonsynonymous SNVs with a consensus deleteriousness score, Condel. Am. J. Hum. Genet. 88, 440-449 (2011).
Grantham, R. Amino acid difference formula to help explain protein evolution. Science 185, 862-864 (1974).
Hindorff, L. A. et al. Potential etiologic and functional implications of genome-wide association loci for human diseases and traits. Proc. Natl. Acad. Sci. USA 106, 9362-9367 (2009).
Hoffman, M. M. et al. Unsupervised pattern discovery in human chromatin structure through genomic segmentation. Nat. Methods 9, 473-476 (2012).
Hubisz, M. J., Pollard, K. S. & Siepel, A. PHAST and RPHAST: phylogenetic analysis with space/time models. Brief Bioinform 12, 41-51 (2011).
Iossifov, I. et al. De novo gene disruptions in children on the autistic spectrum. Neuron 74, 285-99 (2012).
Johnson, D. S., Mortazavi, A., Myers, R. M. & Wold, B. Genome-wide mapping of in vivo protein-DNA interactions. Science 316, 1497-1502 (2007).
Khurana, E., Fu, Y., Chen, J. & Gerstein, M. Interpretation of genomic variants using a unified biological network approach. PLoS Comput Biol 9, e1002886 (2013).
Kimura, M. The Neutral Theory of Molecular Evolution (Cambridge University Press, Cambridge and New York, 1983).
Liao, B. Y. & Zhang, J. Null mutations in human and mouse orthologs frequently result in different phenotypes. Proc Natl Acad Sci USA 105, 6987-92 (2008).
Liu, X., Jian, X. & Boerwinkle, E. dbNSFP: a lightweight database of human nonsynonymous SNPs and their functional predictions. Hum Mutat 32, 894-9 (2011).
MacArthur, D. G. et al. A systematic survey of loss-of-function variants in human protein-coding genes. Science 335, 823-8 (2012).
Makrythanasis, P. et al. MLL2 mutation detection in 86 patients with Kabuki syndrome: a genotype-phenotype study. Clin Genet (2013).
McLaren, W. et al. Deriving the consequences of genomic variants with the Ensembl API and SNP Effect Predictor. Bioinformatics 26, 2069-70 (2010).
McVicker, G., Gordon, D., Davis, C. & Green, P. Widespread genomic signatures of natural selection in hominid evolution. PLoS Genet 5, e1000471 (2009).
Meyer, L. R. et al. The UCSC Genome Browser database: extensions and updates 2013. Nucleic Acids Res. 41, D64-D69 (2013).
Meyer, M. et al. A high-coverage genome sequence from an archaic Denisovan individual. Science 338, 222-6 (2012).
Musunuru, K. et al. From noncoding variant to phenotype via SORT1 at the 1p13 cholesterol locus. Nature 466, 714-719 (2010).
Neale, B. M. et al. Patterns and rates of exonic de novo mutations in autism spectrum disorders. Nature 485, 242-5 (2012).
Ng, P. C. & Henikoff, S. SIFT: Predicting amino acid changes that affect protein function. Nucleic Acids Res 31, 3812-4 (2003).
Ng, S. B. et al. Exome sequencing identifies MLL2 mutations as a cause of Kabuki syndrome. Nat. Genet. 42, 790-793 (2010).
Ng, S. B. et al. Targeted capture and massively parallel sequencing of 12 human exomes. Nature 461, 272-276 (2009).
Nicolae, D. L. et al. Trait-associated SNPs are more likely to be eQTLs: annotation to enhance discovery from GWAS. PLoS Genet. 6, e1000888 (2010).
O'Roak, B. J. et al. Exome sequencing in sporadic autism spectrum disorders identifies severe de novo mutations. Nature genetics 43, 585-9 (2011).
O'Roak, B. J. et al. Sporadic autism exomes reveal a highly interconnected protein network of de novo mutations. Nature 485, 246-50 (2012).
Paten, B. et al. Genome-wide nucleotide-level mammalian ancestor reconstruction. Genome Res 18, 1829-43 (2008a).
Paten, B., Herrero, J., Beal, K., Fitzgerald, S. & Birney, E. Enredo and Pecan: genome-wide mammalian consistency-based multiple alignment with paralogs. Genome Res 18, 1814-28 (2008b).
Patwardhan, R. P. et al. High-resolution analysis of DNA regulatory elements by synthetic saturation mutagenesis. Nat Biotechnol 27, 1173-5 (2009).
Patwardhan, R. P. et al. Massively parallel functional dissection of mammalian enhancers in vivo. Nat Biotechnol 30, 265-70 (2012).
Pollard, K. S., Hubisz, M. J., Rosenbloom, K. R. & Siepel, A. Detection of nonneutral substitution rates on mammalian phylogenies. Genome Res. 20, 110-121 (2010).
Rauch, A. et al. Range of genetic mutations associated with severe non-syndromic sporadic intellectual disability: an exome sequencing study. Lancet 380, 1674-1682 (2012).
Rohland, N. & Reich, D. Cost-effective, high-throughput DNA sequencing libraries for multiplexed target capture. Genome Res. 22, 939-946 (2012).
Rosenbloom, K. R. et al. ENCODE whole-genome data in the UCSC Genome Browser: update 2012. Nucleic Acids Res 40, D912-7 (2012).
Sanders, S. J. et al. De novo mutations revealed by whole-exome sequencing are strongly associated with autism. Nature 485, 237-41 (2012).
Schaub, M. A., Boyle, A. P., Kundaje, A., Batzoglou, S. & Snyder, M. Linking disease associations with regulatory information in the human genome. Genome Res. 22, 1748-1759 (2012).
Siepel, A. et al. Evolutionarily conserved elements in vertebrate, insect, worm, and yeast genomes. Genome Res 15, 1034-50 (2005).
Stenson, P. D. et al. The Human Gene Mutation Database: 2008 update. Genome Med 1, 13 (2009).
Tavaré, S. Some probabilistic and statistical problems in the analysis of DNA sequences. Lect. Math. Life Sci 17, 57-86 (1986).
Tennessen, J. A. et al. Evolution and functional impact of rare coding variation from deep sequencing of human exomes. Science 337, 64-9 (2012).
Ward, L. D. & Kellis, M. Interpreting noncoding genetic variation in complex traits and human disease. Nat. Biotechnol. 30, 1095-1106 (2012).
Weedon, M. N. et al. Recessive mutations in a distal PTF1A enhancer cause isolated pancreatic agenesis. Nat. Genet. 46, 61-64 (2014).

1. A method performed by a computing system for determining the relative effect of a genetic variant comprising:
applying a machine learning model to a dataset, wherein the dataset comprises one or more genetic variants, each of which is associated with values or states of each of a set of annotations; and
calculating an integrated deleteriousness score for each of the one or more genetic variants;
wherein the integrated deleteriousness score of each genetic variant is used to determine the relative effect of said genetic variant when compared to a set of reference deleteriousness scores.

2. The method of claim 1, wherein the machine learning model is a support vector machine (SVM) model.

3. The method of claim 2, wherein the SVM model is trained to distinguish between a set of simulated variants and a set of observed variants.

4. The method of claim 2, wherein the SVM model is trained using a linear kernel on features derived from an annotation matrix.

5. The method of claim 4, wherein the SVM model fits a hyperplane defined by:
$$0 = {β}_{0} + {\sum }_{i = 1}^{166} {β}_{i} {X}_{i} + {\sum }_{i = 1}^{5} {\sum }_{j = 1}^{5} {γ}_{ij} {1}_{\{ ith Ref category and j th Alt category \}} + {\sum }_{i = 1}^{21} {\sum }_{j = 1}^{21} {δ}_{ij} {1}_{\{ ith oAA category and jth nAA category \}} + {\sum }_{i = 1}^{11} {τ}_{i} {W}_{i} + {\sum }_{i = 1}^{17} {\sum }_{j ∈ D} {α}_{ij} {1}_{\{ ith Consequence category \}} {X}_{j}$$

6. The method of claim 1, wherein the integrated deleteriousness score is a raw integrated deleteriousness score or a scaled integrated deleteriousness score.

7. The method of claim 1, wherein the set of reference deleteriousness scores are derived from a set of reference variants, a reference gene or genome, or the dataset.

8. A system for generating an integrated deleteriousness score for determining the relative effect of a genetic variant comprising:
a computer-readable storage medium which stores computer-executable instructions comprising
instructions for applying a machine learning model to a dataset, wherein the dataset comprises one or more genetic variants, each of which is associated with values or states of each of a set of annotations, and
instructions for calculating an integrated deleteriousness score to each of the one or more genetic variants;
a processor which is configured to perform steps comprising
receiving the dataset by a user;
executing the computer-executable instructions stored in the computer-readable storage medium.

9. The system of claim 8, wherein the machine learning model is a support vector machine (SVM) model.

10. The system of claim 9, wherein the SVM model is trained to distinguish between a set of simulated variants and a set of observed variants.

11. The system of claim 9, wherein the SVM model is trained using a linear kernel on features derived from an annotation matrix.

12. The system of claim 4, wherein the SVM model fits a hyperplane defined by:
$$0 = {β}_{0} + {\sum }_{i = 1}^{166} {β}_{i} {X}_{i} + {\sum }_{i = 1}^{5} {\sum }_{j = 1}^{5} {γ}_{ij} {1}_{\{ ith Ref category and j th Alt category \}} + {\sum }_{i = 1}^{21} {\sum }_{j = 1}^{21} {δ}_{ij} {1}_{\{ ith oAA category and jth nAA category \}} + {\sum }_{i = 1}^{11} {τ}_{i} {W}_{i} + {\sum }_{i = 1}^{17} {\sum }_{j ∈ D} {α}_{ij} {1}_{\{ ith Consequence category \}} {X}_{j}$$

13. The system of claim 8, wherein the integrated deleteriousness score is a raw integrated deleteriousness score or a scaled integrated deleteriousness score.

14. The system of claim 8, wherein the set of reference deleteriousness scores are derived from a set of reference variants, a reference gene or genome, or the dataset.

15. A computer-readable storage medium which stores computer-executable instructions comprising:
instructions for applying a machine learning model to a dataset, wherein the dataset comprises one or more genetic variants, each of which is associated with values or states of each of a set of annotations, and
instructions for calculating an integrated deleteriousness score to each of the one or more genetic variants.

16. The computer-readable storage medium of claim 15, wherein the machine learning model is a support vector machine (SVM) model.

17. The computer-readable storage medium of claim 16, wherein the SVM model is trained to distinguish between a set of simulated variants and a set of observed variants.

18. The computer-readable storage medium of claim 16, wherein the SVM model is trained using a linear kernel on features derived from an annotation matrix.

19. The computer-readable storage medium of claim 18, wherein the SVM model fits a hyperplane defined by:
$$0 = {β}_{0} + {\sum }_{i = 1}^{166} {β}_{i} {X}_{i} + {\sum }_{i = 1}^{5} {\sum }_{j = 1}^{5} {γ}_{ij} {1}_{\{ ith Ref category and j th Alt category \}} + {\sum }_{i = 1}^{21} {\sum }_{j = 1}^{21} {δ}_{ij} {1}_{\{ ith oAA category and jth nAA category \}} + {\sum }_{i = 1}^{11} {τ}_{i} {W}_{i} + {\sum }_{i = 1}^{17} {\sum }_{j ∈ D} {α}_{ij} {1}_{\{ ith Consequence category \}} {X}_{j}$$

20. (canceled)

21. The computer-readable storage medium of claim 15, wherein the set of reference deleteriousness scores are derived from a set of reference variants, a reference gene or genome, or the dataset.

22. (canceled)
